SEQUENCE LISTING (4 sequences)

SEQ ID NO: 1 - protein, 216 aa, M. smegmatis
MAKRILCFGDSLTWGWVPVEDGAPTERFAPDVRWTGVLAQQLGADFEVIEEGLSARTTNIDDPTDPRLNGASYLPSCLATHLPLDLVIIMLGTNDTKAYFRRTPLDIALGMSVLVTQVLTSAGGVGTTYPAPKVLVVSPPPLAPMPHPWFQLIFEGGEQKTTELARVYSALASFMKVPFFDAGSVISTDGVDGIHFTEANNRDLGVALAEQVRSLL

SEQ ID NO: 2 - DNA, 651 bp, M. smegmatis
atggccaagcgaattctgtgtttcggtgattccctgacctggggctgggtccccgtcgaagacggggcacccaccgagcggttcgcccccgacgtgcgctggaccggtgtgctggcccagcagctcggagcggacttcgaggtgatcgaggagggactgagcgcgcgcaccaccaacatcgacgaccccaccgatccgcggctcaacggcgcgagctacctgccgtcgtgcctcgcgacgcacctgccgctcgacctggtgatcatcatgctgggcaccaacgacaccaaggcctacttccggcgcaccccgctcgacatcgcgctgggcatgtcggtgctcgtcacgcaggtgctcaccagcgcgggcggcgtcggcaccacgtacccggcacccaaggtgctggtggtctcgccgccaccgctggcgcccatgccgcacccctggttccagttgatcttcgagggcggcgagcagaagaccactgagctcgcccgcgtgtacagcgcgctcgcgtcgttcatgaaggtgccgttcttcgacgcgggttcggtgatcagcaccgacggcgtcgacggaatccacttcaccgaggccaacaatcgcgatctcggggtggccctcgcggaacaggtgcggagcctgctgtaa

SEQ ID NO: 3 - protein, 216 aa, M. smegmatis
  misc_feature: S54V variant of the M. smegmatis perhydrolase
MAKRILCFGDSLTWGWVPVEDGAPTERFAPDVRWTGVLAQQLGADFEVIEEGLVARTTNIDDPTDPRLNGASYLPSCLATHLPLDLVIIMLGTNDTKAYFRRTPLDIALGMSVLVTQVLTSAGGVGTTYPAPKVLVVSPPPLAPMPHPWFQLIFEGGEQKTTELARVYSALASFMKVPFFDAGSVISTDGVDGIHFTEANNRDLGVALAEQVRSLL

SEQ ID NO: 4 - protein, 505 aa, Cerrena unicolor
  misc_feature: Laccase enzyme
AIGPVADLHIVNKDLAPDGVQRPTVLAGGTFPGTLITGQKGDNFQLNVIDDLTDDRMLTPTSIHWHGFFQKGTAWADGPAFVTQCPIIADNSFLYDFDVPDQAGTFWYHSHLSTQYCDGLRGAFVVYDPNDPHKDLYDVDDGGTVITLADWYHVLAQTVVGAATPDSTLINGLGRSQTGPADAELAVISVEHNKRYRFRLVSISCDPNFTFSVDGHNMTVIEVDGVNTRPLTVDSIQIFAGQRYSFVLNANQPEDNYWIRAMPNIGRNTTTLDGKNAAILRYKNASVEEPKTVGGPAQSPLNEADLRPLVPAPVPGNAVPGGADINHRLNLTFSNGLFSINNASFTNPSVPALLQILSGAQNAQDLLPTGSYIGLELGKVVELVIPPLAVGGPHPFHLHGHNFWVVRSAGSDEYNFDDAILRDVVSIGAGTDEVTIRFVTDNPGPWFLHCHIDWHLEAGLAIVFAEGINQTAAANPTPQAWDELCPKYNGLSASQKVKPKKGTAI

(19) United States
(12) Patent Application Publication
(10) Pub. No.: US 2012/0149269 A1
(43) Pub. Date: Jun. 14, 2012

(54) Combined Textile Abrading And Color Modification

(75) Inventors: Rafael F. Sala, Mountain View, CA (US); Wayne Ashton, Bamsley (GB); Piera M. Pericu, Voorschoten (NL); Christopher C. Barnett, Granite Bay, CA (US)

(73) Assignee: Danisco US Inc., Palo Alto, CA (US)

(21) Appl. No.: 13/254,116

(22) PCT Filed: Aug. 26, 2010
(86) PCT No.: PCT/US10/46763

§ 371 Date: Oct. 18, 2011

Related U.S. Application Data
(60) Provisional application No. 61/237,534, filed on Aug. 27, 2009.
(60) Provisional application No. 61/238,029, filed on Aug. 28, 2009.

(51) Int. Cl. D03D 15/00; B32B 5/16; D06L 3/16; C12S 11/00; D06L 3/14

(52) U.S. Cl. 442/181; 435/263; 8/115.51; 8/194; 428/221

(57) ABSTRACT

Described are compositions and methods for the enzymatic abrading and color modification of dyed textiles. The compositions and methods permit a textile manufacturer to obtain a wide variety of different textile finishes and colors using exclusively enzymatic methods.

### PRIORITY

The present application claims priority to U.S. Provisional Application Ser. Nos. 61/237,534, filed on Aug. 27, 2009, and 61/238,029, filed on Aug. 28, 2009, which are hereby incorporated by reference in their entirety.

### TECHNICAL FIELD

The present compositions and methods relate to combined enzymatic textile abrading and color adjustment. The composition and methods are based, in part, on the discovery that certain enzymes can be used sequentially, sometimes in the same treatment bath, to produce textiles with a broad range of finishes and colors using only a limited suite of enzymatic systems.

### BACKGROUND

The use of enzymes to process textiles is now well established. Amylases are used for desizing, cellulases are used for abrading and abrading, and catalases are used for bleach clean-up. More recently, enzymes such as perhydrolases and laccases have been applied to textile processing, where such enzymes are used in place of harsh chemical bleaching treatments.

Although enzymatic textiles treatments have greatly reduced the environmental impact of textile processing and produced significant cost saving to textiles producers, the complete manufacture of a textile products continues to require multiple discrete steps, frequently involving separate baths and multiple rinse cycles to remove the reaction components from one process prior to initiating a subsequent process. In addition, enzymatic textile processing has heretofore not been capable of producing the array of finishes and colors demanded by modern textile consumers, thereby limiting it acceptance.

### SUMMARY

Compositions and methods relating to combined enzymatic textile abrading and color adjustment are described.

In one aspect, an enzymatic method for abrading and modifying the color of a dyed textile is provided, comprising: (a) contacting the textile with a cellulase to biopolish the textile; and (b) contacting the textile with a perhydrolase enzyme system to modify the color of the textile; wherein (a) and (b) are performed in a single bath. In some embodiments, (a) and (b) are performed sequentially or simultaneously.

In some embodiments, (a) is preceded by an enzymatic desizing step, which may be performed in the same bath as (a) and (b). In some embodiments, (b) is followed by the addition of a catalase enzyme, which may be added to the same bath in which (a) and (b) are performed.

In another aspect, an enzymatic method for abrading and modifying the color of a dyed textile is provided, comprising: (a) contacting the textile with a composition comprising a cellulase to abrade the textile; (b) contacting the textile with a laccase enzyme system to perform a first color modification of the textile; and (c) contacting the textile with a perhydrolase enzyme system to perform a second color modification of the textile; wherein the overall color modification produced by the combination of (b) and (c) is different from the first color modification in (b) and the second color modification in (c).

In some embodiments, (b) is performed before (c). In some embodiments, (a) and (b) are performed sequentially or simultaneously in a single bath.

In some embodiments, (c) is performed before (b). In some embodiments, (a) and (c) are performed sequentially or simultaneously in a single bath. In some embodiments, i.e., where the order of steps is (a), (c), and (b), (b) is followed by: (d) contacting the textile with the perhydrolase enzyme system to perform a third color modification of the dyed textile.

In some embodiments, (a) is preceded by an enzymatic desizing step, which may be performed in the same bath as (a). In some embodiments, (c) is followed by the addition of a catalase enzyme. In some embodiments, catalase enzyme is added to the same bath in which any of (a), (b), and/or (c) are performed.

Regarding either of the aforementioned aspects, in some embodiments, the cellulase is an acid cellulase. In some embodiments, the cellulase is a neutral cellulase. In some embodiments, the cellulase is an alkaline cellulase. In some embodiments, the cellulase is a combination of cellulases.

In some embodiments of any of the aforementioned aspects, the perhydrolase enzyme system may comprise a perhydrolase enzyme and an ester substrate, wherein the perhydrolase enzyme catalyzes perhydrolysis of the ester substrate with a perhydrolysis:hydrolysis ratio equal to or greater than 1. In some embodiments, the perhydrolase enzyme system comprises a Mycobacterium smegmatis perhydrolase or a variant, thereof. In some embodiments, the perhydrolase enzyme is a S54V variant of Mycobacterium smegmatis perhydrolase, or a variant, thereof.

In some embodiments, the laccase enzyme may be a Cerrena unicolor laccase, or a variant, thereof.

In some embodiments, the textile is denim. In some embodiments, the dye is indigo dye. In some embodiments, the dye is sulfur dye.

In another aspect, a textile produced by any of the preceding methods is provided. In particular embodiments, the textile is indigo-dyed denim. In particular embodiments, the textile is sulfur-dyed denim.

In another aspect, a kit of parts for performing the foregoing methods is provided.

These and other aspects and embodiments of present compositions and methods will be further apparent from the description.

### BRIEF DESCRIPTION OF THE DRAWINGS

FIG. 1 is a table showing exemplary finishes and colors that can be obtained with cone denim XMISP using various embodiments of the present compositions and methods.

FIG. 2 is a table showing exemplary finishes and colors that can be obtained with cone denim 4671P using various embodiments of the present compositions and methods.

FIG. 3 is a table showing exemplary finishes and colors that can be obtained with cone denim 8349P using various embodiments of the present compositions and methods.

FIG. 4 is a table showing exemplary finishes and colors that can be obtained with cone denim W333 using various embodiments of the present compositions and methods.

FIG. 5 is a table showing exemplary finishes and colors that can be obtained with cone denim XOBBP using various embodiments of the present compositions and methods.

### DETAILED DESCRIPTION

### Overview

Described are enzymatic compositions and methods for combined textile abrading and color-modification. In some embodiments, the combined abrading and color modification are performed in a single bath, without the need to rinse the textiles between processing steps. In some embodiments, abrading can be combined with color modification using different enzyme systems, such as perhydrolase enzyme system and a laccase enzyme system, to produce a wide range of finishes and colors. In the case of indigo and/or sulfur-dyed denim, i.e., textiles subjected to a wide range of different chemical and physical treatments in pursuit of fashion, the present compositions and methods offer a comprehensive enzymatic solution for obtaining known finishes and colors, and make possible new finishes and colors.

Combined with previously-described enzymatic desizing and bleach clean-up methods, the present compositions and methods further fulfill the need for start-to-finish enzymatic textile processing solutions that are cost effective, environmentally friendly, and sufficiently versatile to produce a wide range of finishes and colors. These and other features and advantages of the present compositions and methods are further described, herein.

### Definitions

Prior to describing the present compositions and methods in detail, the following terms are defined for clarity. Terms not defined should be given their ordinary meanings as using in the relevant art.

As used herein, a “perhydrolase” is an enzyme capable of catalyzing a perhydrolysis reaction that results in the production of a sufficiently high amount of peracid for use in an oxidative dye decolorization method as described. Generally, the perhydrolase enzyme exhibits a high perhydrolysis to hydrolysis ratio. In some embodiments, the perhydrolase comprises, consists of, or consists essentially of the Mycobacterium smegmatis perhydrolase amino acid sequence set forth in SEQ ID NO: 1, or a variant or homolog thereof. In some embodiments, the perhydrolase enzyme comprises acyltransferase and/or arylesterase activity.

As used herein, the terms “perhydrolyzation,” “perhydrolyze,” or “perhydrolysis” refer to a reaction wherein a peracid is generated from ester and hydrogen peroxide substrate. In some embodiments, the perhydrolyzation reaction is catalyzed with a perhydrolase, e.g., acyl transferase or aryl esterase, enzyme. In some embodiments, a peracid is produced by perhydrolysis of an ester substrate of the formula R₁C(═O)OR₂, where R₁ and R₂ are the same or different organic moieties, in the presence of hydrogen peroxide (H₂O₂). In some embodiments, —OR₂ is —OH. In some embodiments, —OR₂ is replaced by —NH₂. In some embodiments, a peracid is produced by perhydrolysis of a carboxylic acid or amide substrate.

As used herein, an “effective amount of perhydrolase enzyme” refers to the quantity of perhydrolase enzyme necessary to produce the decolorization effects described herein. Such effective amounts are determined by the skilled artisan in view of the present description, and are based on several factors, such as the particular enzyme variant used, the pH used, the temperature used, and the like, as well as the results desired (e.g., level of whiteness).

As used herein, the term “peracid” refers to a molecule derived from a carboxylic acid ester that has been reacted with hydrogen peroxide to form a highly reactive product having the general formula RC(═O)OOH. Such peracid products are able to transfer one of their oxygen atoms to another molecule, such as a dye. It is this ability to transfer oxygen atoms that enables a peracid, for example, peracetic acid, to function as a bleaching agent.

As used herein, an “ester substrate,” with reference to an oxidative dye decolorization system containing a perhydrolase enzyme, refers to a perhydrolase substrate that contains an ester linkage. Esters comprising aliphatic and/or aromatic carboxylic acids and alcohols may be utilized as substrates with perhydrolase enzymes. In some embodiments, the ester source is an acetate ester. In some embodiments, the ester source is selected from one or more of propylene glycol diacetate, ethylene glycol diacetate, triacetin, ethyl acetate and tributyrin. In some embodiments, the ester source is selected from the esters of one or more of the following acids: formic acid, acetic acid, propionic acid, butyric acid, valeric acid, caproic acid, caprylic acid, nonanoic acid, decanoic acid, dodecanoic acid, myristic acid, palmitic acid, stearic acid, and oleic acid.

As used herein, the term “hydrogen peroxide source” refers to a molecule capable of generating hydrogen peroxide, e.g., in situ. Hydrogen peroxide sources include hydrogen peroxide, itself, as well as molecules that spontaneously or enzymatically produce hydrogen peroxide as a reaction product. Such molecules include, e.g., perborate and percarbonate.

As used herein, the phrase “perhydrolysis to hydrolysis ratio” refers to the ratio of enzymatically produced peracid to enzymatically produced acid (e.g., in moles) that is produced by a perhydrolase enzyme from an ester substrate under defined conditions and within a defined time. In some embodiments, the assays provided in WO 05/056782 are used to determine the amounts of peracid and acid produced by the enzyme.

As used herein, the term “acyl” refers to an organic group with the general formula RCO—, derived from an organic acid by removal of the —OH group. Typically, acyl group names end with the suffix “-oyl,” e.g., methanoyl chloride, CH₃CO—Cl, is the acyl chloride formed from methanoic acid, CH₃CO—OH).

As used herein, the term “acylation” refers to a chemical transformation in which one of the substituents of a molecule is substituted by an acyl group, or the process of introduction of an acyl group into a molecule.

As used herein, the term “transferase” refers to an enzyme that catalyzes the transfer of a functional group from one substrate to another substrate. For example, an acyl transferase may transfer an acyl group from an ester substrate to a hydrogen peroxide substrate to form a peracid.

As used herein, the term “hydrogen peroxide generating oxidase” refers to an enzyme that catalyzes an oxidation/reduction reaction involving molecular oxygen (O₂) as the electron acceptor. In such a reaction, oxygen is reduced to water (H₂O) or hydrogen peroxide (H₂O₂). An oxidase suitable for use herein is an oxidase that generates hydrogen peroxide (as opposed to water) on its substrate. An example of a hydrogen peroxide generating oxidase and its substrate suitable for use herein is glucose oxidase and glucose. Other oxidase enzymes that may be used for generation of hydrogen peroxide include alcohol oxidase, ethylene glycol oxidase, glycerol oxidase, amino acid oxidase, etc. In some embodiments, the hydrogen peroxide generating oxidase is a carbohydrate oxidase.

As used herein, a “laccase” is a multi-copper containing oxidase (EC 1.10.3.2) that catalyzes the oxidation of phenols, polyphenols, and anilines by single-electron abstraction, with the concomitant reduction of oxygen to water in a four-electron transfer process.

As used herein, the term “textile” refers to fibers, yarns, fabrics, garments, and non-wovens. The term encompasses textiles made from natural, synthetic (e.g., manufactured), and various natural and synthetic blends. Textiles may be unprocessed or processed fibers, yarns, woven or knit fabrics, non-wovens, and garments and may be made using a variety of materials, some of which are mentioned, herein.

As used herein, a “cellulosic” fiber, yarn or fabric is made at least in part from cellulose. Examples include cotton and non-cotton cellulosic fibers, yarns or fabrics. Cellulosic fibers may optionally include non-cellulosic fibers.

As used herein, a “non-cotton cellulosic” fiber, yarn or fabric is comprised primarily of a cellulose based composition other than cotton. Examples include linen, ramie, jute, flax, rayon, lyocell, cellulose acetate, bamboo and other similar compositions, which are derived from non-cotton cellulosics.

As used herein, a “non-cellulosic” fiber, yarn or fabric is comprised primarily of a material other than cellulose. Examples include polyester, nylon, rayon, acetate, lyocell, and the like.

As used herein, the term “fabric” refers to a manufactured assembly of fibers and/or yarns that has substantial surface area in relation to its thickness and sufficient cohesion to give the assembly useful mechanical strength.

As used herein, the term “dyeing,” refers to applying a color, especially by soaking in a coloring solution, to, for example, textiles.

As used herein, the term “dye” refers to a colored substance (i.e., chromophore) that has an affinity to a substrate to which it is applied. Numerous classes of dyes are described herein.

As used herein, the terms “color modification” and “color adjustment” are used without distinction to refer to any change to the color of a dyed textile resulting from the destruction, modification, or removal of a dye associated with the textile. In some embodiments, the color modification is decolorization (see below). Examples of color modification include but are not limited to, bleaching, fading, imparting a grey cast, altering hue, saturation, or luminescence, and the like. The amount and type of color modification can be determined by comparing the color of a textile following enzymatic treatment with a perhydrolase enzyme (i.e., residual color) to the color of the textile prior to enzymatic treatment (i.e., original color) using known spectrophotometric or visual inspection methods.

As used herein, the terms “decolorizing” and “decolorization” refer to color elimination or reduction via the destruction, modification, or removal of dye, e.g., from an aqueous medium. In some embodiments, decolorizing or decolorization is defined as a percentage of color removal from aqueous medium. The amount of color removal can be determined by comparing the color of a textile following enzymatic treatment with a perhydrolase enzyme (i.e., residual color) to the color of the textile prior to enzymatic treatment (i.e., original color) using known spectrophotometric or visual inspection methods.

As used herein, the term “original color” refers to the color of a dyed textile prior to enzymatic treatment. Original color may be measured using known spectrophotometric or visual inspection methods.

As used herein, the term “residual color” refers to the color of a dyed textile prior to enzymatic treatment. Residual color may be measured using known spectrophotometric or visual inspection methods.

As used herein, the terms “size” or “sizing” refer to compounds used in the textile industry to improve weaving performance by increasing the abrasion resistance and strength of the yarn. Size is usually made of, for example, starch or starch-like compounds.

As used herein, the terms “desize” or “desizing” refer to the process of eliminating size, generally starch, from textiles usually prior to applying special finishes, dyes or bleaches.

As used herein a “desizing enzyme” is an enzyme used to remove size. Exemplary enzymes are amylases and mannanases.

As used herein, a “cellulase” is an enzyme capable of hydrolizing cellulose.

As used herein, an “acid cellulase” is a cellulase having a pH optima in the acidic pH range, for example, from about pH 4.0 to about pH 5.5.

As used herein, a “neutral cellulase” is a cellulase having a pH optima in the neutral pH range, for example, from about pH 5.5 to about pH 7.5.

As used herein, an “alkaline cellulase” is a cellulase having a pH optima in the alkaline pH range, for example, from about pH 7.5 to about pH 11.

As used herein, the term “abrading” refers generally to contacting a textile comprising cellulose fibers with one or more cellulases to produce an effect. Such effects include but are not limited to softening, smoothing, defuzzing, depilling, biopolishing, and/or intentionally distressing the textile, locally or in its entirety. In some cases, more than one abrading step may be desirable.

As used herein, an “aqueous medium” is a solution and/or suspension primarily comprising water as a solvent. The aqueous medium typically includes at least one dye to be decolorized, as well as any number of dissolved or suspended components, including but not limited to surfactants, salts, buffers, stabilizers, complexing agents, chelating agents, builders, metal ions, additional enzymes and substrates, and the like. Exemplary aqueous media are textile dying solutions. Materials such as textile articles, textile fibers, and other solid materials may also be present in or in contact with the aqueous medium.

As used herein, the term “contacting,” means bringing into physical contact, such as by incubating a subject item (e.g., a textile) in the presence of an aqueous solution containing a reaction component (e.g., an enzyme).

As used herein, the term “sequential,” with reference to a plurality of enzymatic treatments of a textile, means that a second specified enzymatic treatment is performed after a first specified enzymatic treatment is performed. Sequential treatments may be separated by intervening wash steps. Where specified, sequential enzymatic treatments may be performed “in the same bath,” meaning in the substantially the same liquid medium without intervening wash steps. Single-bath sequential treatment may include pH adjustments, temperature adjustment, and/or the addition of salts, activators, mediators, and the like, but should not include washes, rinses, or “dropping the bath” between first and second enzymatic treatments.

As used herein, the term “simultaneous,” with reference to a plurality of enzymatic treatments of a textile, means that a second specified enzymatic treatment is performed at the same time (i.e., at least partially overlapping with) as a first specified enzymatic treatment. Simultaneous enzymatic treatments are necessarily performed “in the same bath” without intervening wash steps.

As used herein, “packaging” refers to a container capable of providing a perhydrolase enzyme, substrate for the perhydrolase enzyme, and/or hydrogen peroxide source in an easy to handle and transport form. Exemplary packaging includes boxes, tubs, cans, barrels, drums, bags, or even tanker trucks.

As used herein, the terms “purified” and “isolated” refer to the removal of contaminants from a sample and/or to a material (e.g., a protein, nucleic acid, cell, etc.) that is removed from at least one component with which it is naturally associated. For example, these terms may refer to a material which is substantially or essentially free from components which normally accompany it as found in its native state, such as, for example, an intact biological system

As used herein, the term “polynucleotide” refers to a polymeric form of nucleotides of any length and any three-dimensional structure and single- or multi-stranded (e.g., single-stranded, double-stranded, triple-helical, etc.), which contain deoxyribonucleotides, ribonucleotides, and/or analogs or modified forms of deoxyribonucleotides or ribonucleotides, including modified nucleotides or bases or their analogs. Because the genetic code is degenerate, more than one codon may be used to encode a particular amino acid. Any type of modified nucleotide or nucleotide analog may be used, so long as the polynucleotide retains the desired functionality under conditions of use, including modifications that increase nuclease resistance (e.g., deoxy, 2′-O-Me, phosphorothioates, etc.). Labels may also be incorporated for purposes of detection or capture, for example, radioactive or nonradioactive labels or anchors, e.g., biotin. The term polynucleotide also includes peptide nucleic acids (PNA). Polynucleotides may be naturally occurring or non-naturally occurring. The terms “polynucleotide” and “nucleic acid” and “oligonucleotide” are used herein interchangeably. Polynucleotides may contain RNA, DNA, or both, and/or modified forms and/or analogs thereof. A sequence of nucleotides may be interrupted by non-nucleotide components. One or more phosphodiester linkages may be replaced by alternative linking groups. These alternative linking groups include, but are not limited to, embodiments wherein phosphate is replaced by P(O)S (“thioate”), P(S)S (“dithioate”), (O)NR₂ (“amidate”), P(O)R, P(O)OR′, CO or CH₂ (“formacetal”), in which each R or R′ is independently H or substituted or unsubstituted alkyl (1-20 C) optionally containing an ether (—O—) linkage, aryl, alkenyl, cycloalkyl, cycloalkenyl or araldyl. Not all linkages in a polynucleotide need be identical. Polynucleotides may be linear or circular or comprise a combination of linear and circular portions.

As used herein, “polypeptide” refers to any composition comprised of amino acids and recognized as a protein by those of skill in the art. The conventional one-letter or three-letter code for amino acid residues is used herein. The terms “polypeptide” and “protein” are used interchangeably herein to refer to polymers of amino acids of any length. The polymer may be linear or branched, it may comprise modified amino acids, and it may be interrupted by non-amino acids. The terms also encompass an amino acid polymer that has been modified naturally or by intervention; for example, disulfide bond formation, glycosylation, lipidation, acetylation, phosphorylation, or any other manipulation or modification, such as conjugation with a labeling component. Also included within the definition are, for example, polypeptides containing one or more analogs of an amino acid (including, for example, unnatural amino acids, etc.), as well as other modifications known in the art.

As used herein, functionally and/or structurally similar proteins are considered to be “related proteins.” In some embodiments, these proteins are derived from a different genus and/or species, including differences between classes of organisms (e.g., a bacterial protein and a fungal protein). In additional embodiments, related proteins are provided from the same species. Indeed, it is not intended that the processes, methods and/or compositions described herein be limited to related proteins from any particular source(s). In addition, the term “related proteins” encompasses tertiary structural homologs and primary sequence homologs. In further embodiments, the term encompasses proteins that are immunologically cross-reactive.

As used herein, the term “derivative” refers to a protein which is derived from a protein by addition of one or more amino acids to either or both the C- and N-terminal end(s), substitution of one or more amino acids at one or a number of different sites in the amino acid sequence, and/or deletion of one or more amino acids at either or both ends of the protein or at one or more sites in the amino acid sequence, and/or insertion of one or more amino acids at one or more sites in the amino acid sequence. The preparation of a protein derivative is preferably achieved by modifying a DNA sequence which encodes for the native protein, transformation of that DNA sequence into a suitable host, and expression of the modified DNA sequence to form the derivative protein.

Related (and derivative) proteins comprise “variant proteins.” In some embodiments, variant proteins differ from a parent protein, e.g., a wild-type protein, and one another by a small number of amino acid residues. The number of differing amino acid residues may be one or more, for example, 1, 2, 3, 4, 5, 10, 15, 20, 30, 40, 50, or more amino acid residues. In some aspects, related proteins and particularly variant proteins comprise at least 35%, 40%, 45%, 50%, 55%, 60%, 65%, 70%, 75%, 80%, 85%, 90%, 91%, 92%, 93%, 94%, 95%, 96%, 97%, 98%, or even 99% or more amino acid sequence identity. Additionally, a related protein or a variant protein refers to a protein that differs from another related protein or a parent protein in the number of prominent regions. For example, in some embodiments, variant proteins have 1, 2, 3, 4, 5, or 10 corresponding prominent regions that differ from the parent protein. Prominent regions include structural features, conserved regions, epitopes, domains, motifs, and the like.

Methods are known in the art that are suitable for generating variants of the enzymes described herein, including but not limited to site-saturation mutagenesis, scanning mutagenesis, insertional mutagenesis, random mutagenesis, site-directed mutagenesis, and directed-evolution, as well as various other recombinatorial approaches. Note that where a particular mutation in a variant polypeptide is specified, further variants of that variant polypeptide retain the specified mutation and vary at other positions not specified.

As used herein, the term “analogous sequence” refers to a sequence within a protein that provides similar function, tertiary structure, and/or conserved residues as the protein of interest (i.e., typically the original protein of interest). For example, in epitope regions that contain an alpha-helix or a beta-sheet structure, the replacement amino acids in the analogous sequence preferably maintain the same specific structure. The term also refers to nucleotide sequences, as well as amino acid sequences. In some embodiments, analogous sequences are developed such that the replacement amino acids result in a variant enzyme showing a similar or improved function. In some embodiments, the tertiary structure and/or conserved residues of the amino acids in the protein of interest are located at or near the segment or fragment of interest. Thus, where the segment or fragment of interest contains, for example, an alpha-helix or a beta-sheet structure, the replacement amino acids preferably maintain that specific structure.

As used herein, the term “homologous protein” refers to a protein that has similar activity and/or structure to a reference protein. It is not intended that homologs necessarily be evolutionarily related. Thus, it is intended that the term encompass the same, similar, or corresponding enzyme(s) (i.e., in terms of structure and function) obtained from different organisms. In some embodiments, it is desirable to identify a homolog that has a quaternary, tertiary and/or primary structure similar to the reference protein. In some embodiments, homologous proteins induce similar immunological response(s) as a reference protein. In some embodiments, homologous proteins are engineered to produce enzymes with desired activity(ies).

The degree of homology between sequences may be determined using any suitable method known in the art (see, e.g., Smith and Waterman (1981) Adv. Appl. Math. 2:482; Needleman and Wunsch (1970) J. Mol. Biol., 48:443; Pearson and Lipman (1988) Proc. Natl. Acad. Sci. USA 85:2444; programs such as GAP, BESTFIT, FASTA, and TFASTA in the Wisconsin Genetics Software Package (Genetics Computer Group, Madison, Wis.); and Devereux et al. (1984) Nucleic Acids Res. 12:387-395).

For example, PILEUP is a useful program to determine sequence homology levels. PILEUP creates a multiple sequence alignment from a group of related sequences using progressive, pair-wise alignments. It can also plot a tree showing the clustering relationships used to create the alignment. PILEUP uses a simplification of the progressive alignment method of Feng and Doolittle, (Feng and Doolittle (1987) J. Mol. Evol. 35:351-360). The method is similar to that described by Higgins and Sharp (Higgins and Sharp (1989) CABIOS 5:151-153). Useful PILEUP parameters including a default gap weight of 3.00, a default gap length weight of 0.10, and weighted end gaps. Another example of a useful algorithm is the BLAST algorithm, described by Altschul et al. (Altschul et al. (1990) J. Mol. Biol. 215:403-410; and Karlin et al. (1993) Proc. Natl. Acad. Sci. USA 90:5873-5787). One particularly useful BLAST program is the WU-BLAST-2 program (See, Altschul et al. (1996) Meth. Enzymol. 266:460-480). Parameters “W,” “T,” and “X” determine the sensitivity and speed of the alignment. The BLAST program uses as defaults a word-length (W) of 11, the BLOSUM62 scoring matrix (See, Henikoff and Henikoff (1989) Proc. Natl. Acad. Sci. USA 89:10915) alignments (B) of 50, expectation (E) of 10, M′5, N′-4, and a comparison of both strands.

As used herein, the phrases “substantially similar” and “substantially identical,” in the context of at least two nucleic acids or polypeptides, typically means that a polynucleotide or polypeptide comprises a sequence that has at least about 40% identity, more preferable at least about 50% identity, yet more preferably at least about 60% identity, preferably at least about 75% identity, more preferably at least about 80% identity, yet more preferably at least about 90%, at least about 91%, at least about 92%, at least about 93%, at least about 94%, at least about 95%, at least about 96%, at least about 97%, at least about 98%, or even at least about 99% sequence identity, compared to the reference (i.e., wild-type) sequence. Sequence identity may be determined using known programs such as BLAST, ALIGN, and CLUSTAL using standard parameters. (See e.g., Altschul, et al. (1990) J. Mol. Biol. 215:403-410; Henikoff et al. (1989) Proc. Natl. Acad. Sci. USA 89:10915; Karin et al. (1993) Proc. Natl. Acad. Sci. USA 90:5873; and Higgins et al. (1988) Gene 73:237-244). Software for performing BLAST analyses is publicly available through the National Center for Biotechnology Information. Also, databases may be searched using FASTA (Pearson et al. (1988) Proc. Natl. Acad. Sci. USA 85:2444-2448). One indication that two polypeptides are substantially identical is that the first polypeptide is immunologically cross-reactive with the second polypeptide. Typically, polypeptides that differ by conservative amino acid substitutions are immunologically cross-reactive. Thus, a polypeptide is substantially identical to a second polypeptide, for example, where the two peptides differ only by a conservative substitution. Another indication that two nucleic acid sequences are substantially identical is that the two molecules hybridize to each other under stringent conditions (e.g., within a range of medium to high stringency).

As used herein, “wild-type” and “native” proteins are those found in nature. The terms “wild-type sequence,” and “wild-type gene” are used interchangeably herein, to refer to a sequence that is native or naturally occurring in a host cell. In some embodiments, the wild-type sequence refers to a sequence of interest that is the starting point of a protein engineering project. The genes encoding the naturally-occurring protein may be obtained in accord with the general methods known to those skilled in the art. The methods generally comprise synthesizing labeled probes having putative sequences encoding regions of the protein of interest, preparing genomic libraries from organisms expressing the protein, and screening the libraries for the gene of interest by hybridization to the probes. Positively hybridizing clones are then mapped and sequenced.

As used herein, the singular articles “a,” “an,” and “the” encompass the plural referents unless the context clearly dictates otherwise. All references sited herein are hereby incorporated by reference in their entirety.

The following abbreviations/acronyms have the following meanings unless otherwise specified:
cDNA complementary DNA
DNA deoxyribonucleic acid
EC enzyme commission
kDa kiloDalton
MW molecular weight
SDS-PAGE sodium dodecyl sulfate polyacrylamide gel electrophoresis
w/v weight/volume
w/w weight/weight
v/v volume/volume
wt % weight percent
° C. degrees Centigrade
H₂O water
H₂O₂ hydrogen peroxide
dH₂O or DI deionized water
dIH₂O deionized water, Milli-Q filtration
g or gm gram
μ microgram
mg milligram
kg kilogram
μL and μl microliter
mL and ml milliliter
mm millimeter
μm micrometer
M molar
mM millimolar
μM micromolar
U unit
ppm parts per million
sec and ″ second
min and ′ minute
hr hour
ETOH ethanol
eq. equivalent
N normal
CI Colour (Color) Index
CAS Chemical Abstracts Society

### Cellulases

In some embodiments, color modification is performed sequentially or simultaneously in the same bath as abrading using one or more cellulase enzymes. Cellulases are typically used prior to, or concurrent with, treatment with a perhydrolase system or laccase system. In some embodiments, a plurality of cellulases may be used together or separately in different steps.

Cellulases are classified in enzyme families encompassing endo- and exo-activities as well as cellobiose hydrolyzing capability. Cellulases are also characterized as acid cellulases, neutral cellulases, or alkaline cellulases, based on their pH optima.

Cellulases may be derived from microorganisms which are known to be capable of producing cellulolytic enzymes, such as, e.g., species of Trichoderma, Humicola, Fusarium, Aspergillus, Thermomyces, Bacillus, Myceliophthora, Phanerochaete, Irpex, Scytalidium, Schizophyllum, Penicillium, Geotricum, and Staphylotrichum. Known species capable for producing celluloytic enzymes include Humicola insolens, Fusarium oxysporum or Trichoderma reesei. Exemplary cellulases include the endoglucanase from Streptomyces sp. 11AG8, the neutral cellulases from Staphylotrichum coccosporum and Humicola insolens, and individual cellulases and cellulase blends from T. reesei.

Non-limiting examples of suitable cellulases are disclosed in U.S. Pat. No. 4,435,307; European Patent Application Nos. EP 0 495 257 and EP 271 004; and PCT Patent Application No. WO91/17244, WO92/06221, WO98/003667. WO01/090375, WO05/054475, and WO05/056787.

In some embodiments, the cellulase may be used in a concentration in the range from about 0.0001% to about 1% enzyme protein by weight of the fabric, such as about 0.0001% to about 0.05% enzyme protein by weight of the fabric, or about 0.0001 to about 0.01% enzyme protein by weight of the fabric.

The cellulolytic activity may be determined in endo-cellulase units (ECU) by measuring the ability of the enzyme to reduce the viscosity of a solution of carboxymethyl cellulose (CMC), The ECU assay quantifies the amount of catalytic activity present in the sample by measuring the ability of the sample to reduce the viscosity of a solution of carboxy-methylcellulose (CMC). The assay is carried out in a vibration viscosimeter (e.g., MIVI 3000 from Sofraser, France) at 40° C.; pH 7.5; 0.1 M phosphate buffer; time 30 minutes using a relative enzyme standard for reducing the viscosity of the CHIC substrate (Hercules 7 LED), enzyme concentration approx. 0.15 ECU/ml. The arch standard is defined to 8200 ECU/g. One ECU is amount of enzyme that reduces the viscosity to one half under these conditions.

### Perhydrolase Enzyme System

The present compositions and methods utilize a perhydrolase enzyme system, comprising a perhydrolase enzyme capable of generating peracids in the present of a suitable ester substrate and hydrogen peroxide source.

In some embodiments, the perhydrolase enzyme is naturally-occurring enzyme. In some embodiments, a perhydrolase enzyme comprises, consists of, or consists essentially of an amino acid sequence that is at least about 70%, 75%, 80%, 85%, 90%, 91%, 92%, 93%, 94%, 95%, 96%, 97%, 98%, 99%, or even 99.5% identical to the amino acid sequence of a naturally-occurring perhydrolase enzyme. In some embodiments, the perhydrolase enzyme is from a microbial source, such as a bacterium or fungus.

In some embodiments, the perhydrolase enzyme is a naturally occurring Mycobacterium smegmatis perhydrolase enzyme or a variant thereof. This enzyme, its enzymatic properties, its structure, and numerous variants and homologs, thereof, are described in detail in International Patent Application Publications WO 05/056782A and WO 08/063,400A and U.S. Patent Application Publications US2008145353 and US2007167344, which are incorporated by reference.

In some embodiments, the perhydrolase enzyme has a perhydrolysis:hydrolysis ratio of at least 1. In some embodiments, the perhydrolase enzyme has a perhydrolysis:hydrolysis ratio greater than 1. In some embodiments, the perhydrolysis:hydrolysis ratio is greater than 1.5, greater than 2.0, greater than 2.5, or even greater than 3.0. These high perhydrolysis:hydrolysis ratios are features unique to of M. smegmatis perhydrolase and variants, thereof.

The amino acid sequence of M. smegmatis perhydrolase is shown below (SEQ ID NO. 1):

MAKRILCFGDSLTWGWVPVEDGAPTERFAPDVRWTGVLAQQLGADFEVIE
EGLSARTTNIDDPTDPRLNGASYLPSCLATHLPLDLVIIMLGTNDTKAYF
RRTPLDIALGMSVLVTQVLTSAGGVGTTYPAPKVLVVSPPPLAPMPHPWF
QLIFEGGEQKTTELARVYSALASFMKVPFFDAGSVISTDGVDGIHFTEAN
NRDLGVALAEQVRSLL

The corresponding polynucleotide sequence encoding M. smegmatis perhydrolase is shown below (SEQ ID NO: 2):

5′-ATGGCCAAGCGAATTCTGTGTTTCGGTGATTCCCTGACCTGGGGCTG
GGTCCCCGTCGAAGACGGGGCACCCACCGAGCGGTTCGCCCCCGACGTGC
GCTGGACCGGTGTGCTGGCCCAGCAGCTCGGAGCGGACTTCGAGGTGATC
GAGGAGGGACTGAGCGCGCGCACCACCAACATCGACGACCCCACCGATCC
GCGGCTCAACGGCGCGAGCTACCTGCCGTCGTGCCTCGCGACGCACCTGC
CGCTCGACCTGGTGATCATCATGCTGGGCACCAACGACACCAAGGCCTAC
TTCCGGCGCACCCCGCTCGACATCGCGCTGGGCATGTCGGTGCTCGTCAC
GCAGGTGCTCACCAGCGCGGGCGGCGTCGGCACCACGTACCCGGCACCCA
AGGTGCTGGTGGTCTCGCCGCCACCGCTGGCGCCCATGCCGCACCCCTGG
TTCCAGTTGATCTTCGAGGGCGGCGAGCAGAAGACCACTGAGCTCGCCCG
CGTGTACAGCGCGCTCGCGTCGTTCATGAAGGTGCCGTTCTTCGACGCGG
GTTCGGTGATCAGCACCGACGGCGTCGACGGAATCCACTTCACCGAGGCC
AACAATCGCGATCTCGGGGTGGCCCTCGCGGAACAGGTGCGGAGCCTGCT
GTAA-3′

In some embodiments, a perhydrolase enzyme comprises, consists of, or consists essentially of the amino acid sequence set forth in SEQ ID NO: 1 or a variant or homologue thereof. In some embodiments, the perhydrolase enzyme comprises, consists of, or consists essentially of an amino acid sequence that is at least about 70%, 75%, 80%, 85%, 90%, 91%, 92%, 93%, 94%, 95%, 96%, 97%, 98%, 99%, or even 99.5% identical to the amino acid sequence set forth in SEQ ID NO: 1.

In some embodiments, the perhydrolase enzyme comprises one or more substitutions at one or more amino acid positions equivalent to position(s) in the M. smegmatis perhydrolase amino acid sequence set forth in SEQ ID NO: 1. In some embodiments, the perhydrolase enzyme comprises any one or any combination of substitutions of amino acids selected from M1, K3, R4, I5, L6, C7, D10, S11, L12, T13, W14, W16, G15, V17, P18, V19, D21, G22, A23, P24, T25, E26, R27, F28, A29, P30, D31, V32, R33, W34, T35, G36, L38, Q40, Q41, D45, L42, G43, A44, F46, E47, V48, I49, E50, E51, G52, L53, S54, A55, R56, T57, T58, N59, I60, D61, D62, P63, T64, D65, P66, R67, L68, N69, G70, A71, S72, Y73, S76, C77, L78, A79, T80, L82, P83, L84, D85, L86, V87, N94, D95, T96, K97, Y99F100, R101, R102, P104, L105, D106, I107, A108, L109, G110, M111, S112, V113, L114, V115, T116, Q117, V118, L119, T120, S121, A122, G124, V125, G126, T127, T128, Y129, P146, P148, W149, F150, I153, F154, I194, and F196.

In some embodiments, the perhydrolase enzyme comprises one or more of the following substitutions at one or more amino acid positions equivalent to position(s) in the M. smegmatis perhydrolase amino acid sequence set forth in SEQ ID NO: 1: L12C, Q, or G; T25S, G, or P; L53H, Q, G, or S; S54V, L A, P, T, or R; A55G or T; R67T, Q, N, G, E, L, or F; K97R; V125S, G, R, A, or P; F154Y; F196G.

In some embodiments, the perhydrolase enzyme comprises a combination of amino acid substitutions at amino acid positions equivalent to amino acid positions in the M. smegmatis perhydrolase amino acid sequence set forth in SEQ ID NO: 1: L12I S54V; L12M S54T; L12T S54V; L12Q T25S S54V; L53H S54V; S54P V125R; S54V V125G; S54V F196G; S54V K97R V125G; or A55G R67T K97R V125G.

In particular embodiments, the perhydrolase enzyme is the S54V variant of the M. smegmatis perhydrolase, which is shown, below (SEQ ID NO: 3); S54V substitution underlined):

MAKRILCFGDSLTWGWVPVEDGAPTERFAPDVRWTGVLAQQLGADFEVIE
EGLVARTTNIDDPTDPRLNGASYLPSCLATHLPLDLVIIMLGTNDTKAYF
RRTPLDIALGMSVLVTQVLTSAGGVGTTYPAPKVLVVSPPPLAPMPHPWF
QLIFEGGEQKTTELARVYSALASFMKVPFFDAGSVISTDGVDGIHFTEAN
NRDLGVALAEQVRSLL

In some embodiments, the perhydrolase enzyme includes the S54V substitution but is otherwise at least about 70%, 75%, 80%, 85%, 90%, 91%, 92%, 93%, 94%, 95%, 96%, 97%, 98%, 99%, or even 99.5% identical to the amino acid sequence set forth in SEQ ID NOs: 1 or 3.

In some embodiments, the perhydrolase enzyme is provided at a concentration of about 1 to about 100 ppm, or more. In some embodiments, the perhydrolase enzyme is provided at a molar ratio with respect to the amount of dye on the textile. In some embodiments, the molar ratio is from about 1/10,000 to about 1/10, or even from about ⅕,000 to about 1/100. In some embodiments, the concentration of perhydrolase enzyme is from about 10⁻⁹ M to about 10⁻⁵ M, from about 10⁻⁸ M to about 10⁻⁵ M, from about 10⁻⁸ M to about 10⁻⁶ M, about 5×10⁻⁸ M to about 5×10⁻⁷ M, or even about 10⁻⁷ M to about 5×10⁻⁷ M. In some embodiments, the amount of perhydrolase enzyme is below a predetermined amount to improve the efficiency of color modification.

The perhydrolase enzyme system may include at least one ester molecule that serves as a substrate for the perhydrolase enzyme for production of a peracid in the presence of hydrogen peroxide. In some embodiments, the ester substrate is an ester of an aliphatic and/or aromatic carboxylic acid or alcohol. The ester substrate may be a mono-, di-, or multivalent ester, or a mixture thereof. For example, the ester substrate may be a carboxylic acid and a single alcohol (monovalent, e.g., ethyl acetate, propyl acetate), two carboxylic acids and a diol [e.g., propylene glycol diacetate (PGDA), ethylene glycol diacetate (EGDA), or a mixture, for example, 2-acetyloxy 1-propionate, where propylene glycol has an acetate ester on alcohol group 2 and a propyl ester on alcohol group 1], or three carboxylic acids and a triol (e.g., glycerol triacetate or a mixture of acetate/propionate, etc., attached to glycerol or another multivalent alcohol).

In some embodiments, the ester substrate is an ester of a nitroalcohol (e.g., 2-nitro-1-propanol). In some embodiments, the ester substrate is a polymeric ester, for example, a partially acylated (acetylated, propionylated, etc.) poly carboxy alcohol, acetylated starch, etc. In some embodiments, the ester substrate is an ester of one or more of the following: formic acid, acetic acid, propionic acid, butyric acid, valeric acid, caproic acid, caprylic acid, nonanoic acid, decanoic acid, dodecanoic acid, myristic acid, palmitic acid, stearic acid, and oleic acid. In some embodiments, triacetin, tributyrin, and other esters serve as acyl donors for peracid formation. In some embodiments, the ester substrate is propylene glycol diacetate, ethylene glycol diacetate, or ethyl acetate. In one embodiment, the ester substrate is propylene glycol diacetate.

As noted above, suitable substrates may be monovalent (i.e., comprising a single carboxylic acid ester moiety) or plurivalent (i.e., comprising more than one carboxylic acid ester moiety). The amount of substrate used for color modification may be adjusted depending on the number carboxylic acid ester moieties in the substrate molecule. In some embodiments, the concentration of carboxylic acid ester moieties in the aqueous medium is about 20-500 mM, for example, about 40 mM to about 400 mM, about 40 mM to about 200 mM, or even about 60 mM to about 200 mM. Exemplary concentrations of carboxylic acid ester moieties include about 60 mM, about 80 mM, about 100 mM, about 120 mM, about 140 mM, about 160 mM, about 180 mM, and about 200 mM.

In some embodiments, where the ester substrate is divalent (as in the case of EGDA) it is provided in an amount of about 10-200 mM, for example, about 20 mM to about 200 mM, about 20 mM to about 100 mM, or even about 30 mM to about 100 mM. Exemplary amounts of ester substrate include about 30 mM, about 40 mM, about 50 mM, about 60 mM, about 70 mM, about 80 mM, about 90 mM, and about 100 mM. The skilled person can readily calculate the corresponding amounts of trivalent, or other plurivalent ester substrates based on the number of carboxylic acid esters moieties per molecule.

In some embodiments, the ester substrate is provided in a molar excess with respect to the molar amount of dye on the textile to be subjected to color modification. In some embodiments, the carboxylic acid ester moieties of the ester substrate are provided at about 20 to about 20,000 times the molar amount of dye. Exemplary molar ratios of carboxylic acid ester moieties to dye molecules are from about 100/1 to about 10,000/1, from about 1,000/1 to about 10,000/1, or even 2,000/1 to about 6,000/1. In some cases, the molar ratio of ester substrate to dye molecules is at least 2,000/1, or at least 6,000/1.

In some embodiments, where the ester substrate is divalent (as in the case of EGDA) the ester substrate is provided at about 10 to about 10,000 times the molar amount of dye. Exemplary molar ratios of ester substrate to dye molecules are from about 50/1 to about 5,000/1, from about 500/1 to about 5,000/1, or even 1,000/1 to about 3,000/1. In some cases, the molar ratio of ester substrate to dye molecules is at least 1,000/1, or at least 3,000/1. As before, the skilled person can readily calculate the corresponding amounts of trivalent, or other plurivalent ester substrates based on the number of carboxylic acid esters moieties per molecule.

In some embodiments, the ester substrate is provided at a concentration of about 100 ppm to about 100,000 ppm, ppm, or about 2500 to about 3500 ppm. In some embodiments, the ester substrate is provided in a molar excess with respect to the perhydrolase enzyme. In some embodiments, the molar ratio of carboxylic acid ester moieties to perhydrolase enzyme is at least about 2×10⁵/1, at least about 4×10⁵/1, at least about 1×10⁶/1, at least about 2×10⁶/1, at least about 4×10⁶/1, or even at least about 1×10⁷/1, or more. In some embodiments, the ester substrate is provided in a molar excess of from about 4×10⁵/1, to about 4×10⁶/1, with respect to the perhydrolase enzyme.

In some embodiments, where the ester substrate is divalent (as in the case of EGDA), the molar ratio of ester substrate to perhydrolase enzyme is at least about 1×10⁵/1, at least about 2×10⁵/1, at least about 5×10⁵/1, at least about 1×10⁶/1, at least about 2×10⁶/1, or even at least about 5×10⁶/1, or more. In some embodiments, the ester substrate is provided in a molar excess of from about 2×10⁵/1 to about 2×10⁶/1, with respect to the perhydrolase enzyme. The skilled person can readily calculate the corresponding amounts of trivalent, or other plurivalent ester substrates based on the number of carboxylic acid esters moieties per molecule.

The perhydrolase enzyme system further includes at least one hydrogen peroxide source. Generally, hydrogen peroxide can be provided directly (i.e., in batch), or generated continuously (i.e., in situ) by chemical, electro-chemical, and/or enzymatic means.

In some embodiments, the hydrogen peroxide source is hydrogen peroxide, itself. In some embodiments, the hydrogen peroxide source is a compound that generates hydrogen peroxide upon addition to water. The compound may be a solid compound. Such compounds include adducts of hydrogen peroxide with various inorganic or organic compounds, of which the most widely employed is sodium carbonate per hydrate, also referred to as sodium percarbonate.

In some embodiments, the hydrogen peroxide source is an inorganic perhydrate salt. Examples of inorganic perhydrate salts are perborate, percarbonate, perphosphate, persulfate and persilicate salts. Inorganic perhydrate salts are normally alkali metal salts. Additional hydrogen peroxide sources include adducts of hydrogen peroxide with zeolites, or urea hydrogen peroxide.

The hydrogen peroxide source may be in a crystalline form and/or substantially pure solid form without additional protection. For certain perhydrate salts, preferred forms are granular compositions involving a coating, which provides better storage stability for the perhydrate salt in the granular product. Suitable coatings comprise inorganic salts such as alkali metal silicate, carbonate or borate salts or mixtures thereof, or organic materials such as waxes, oils, or fatty soaps.

In some embodiments, the hydrogen peroxide source is an enzymatic hydrogen peroxide generation system. In one embodiment, the enzymatic hydrogen peroxide generation system comprises an oxidase and its substrate. Suitable oxidase enzymes include, but are not limited to: glucose oxidase, sorbitol oxidase, hexose oxidase, choline oxidase, alcohol oxidase, glycerol oxidase, cholesterol oxidase, pyranose oxidase, carboxyalcohol oxidase, L-amino acid oxidase, glycine oxidase, pyruvate oxidase, glutamate oxidase, sarcosine oxidase, lysine oxidase, lactate oxidase, vanillyl oxidase, glycolate oxidase, galactose oxidase, uricase, oxalate oxidase, and xanthine oxidase.

The following equation provides an example of a coupled system for enzymatic production of hydrogen peroxide.

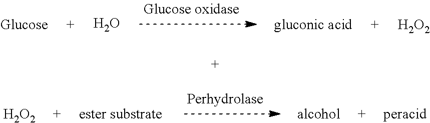

It is not intended that the generation of H₂O₂ be limited to any specific enzyme, as any enzyme that generates H₂O₂ with a suitable substrate may be used. For example, lactate oxidases from Lactobacillus species known to create H₂O₂ from lactic acid and oxygen may be used. One advantage of such a reaction is the enzymatic generation of acid (e.g., gluconic acid in the above example), which reduces the pH of a basic aqueous solution to within the pH range in which peracid is most effective in bleaching (i.e., at or below the pKa). Such a reduction in pH is also brought about directly by the production of peracid. Other enzymes (e.g., alcohol oxidase, ethylene glycol oxidase, glycerol oxidase, amino acid oxidase, etc.) that are capable of generating hydrogen peroxide may also be used with ester substrates in combination with a perhydrolase enzyme to generate peracids.

Where hydrogen peroxide is generated electrochemically, it may be produced, for example, using a fuel cell supplied with oxygen and hydrogen gas.

In some embodiments, hydrogen peroxide is provided at a concentration of about 100 ppm to about 10,000 ppm, about 1,000 ppm to about 3,000 ppm, or about 1,500 to about 2,500 ppm. In some embodiments, hydrogen peroxide is provided at about 10 to about 1,000 times the molar amount of dye.

In some embodiments, hydrogen peroxide is provided in an amount of about 10-200 mM, for example, about 20 mM to about 200 mM, about 20 mM to about 100 mM, or even about 30 mM to about 100 mM. Exemplary amounts of hydrogen peroxide include about 30 mM, about 40 mM, about 50 mM, about 60 mM, about 70 mM, about 80 mM, about 90 mM, and about 100 mM.

In some embodiments, hydrogen peroxide is provided in a molar excess with respect to the molar amount of dye to be subjected to color modification. In some embodiments, the hydrogen peroxide is provided at about 10 to about 10,000 times the molar amount of dye. Exemplary molar ratios of hydrogen peroxide to dye molecules are from about 500/1 to about 5,000/1, or even 1,000/1 to about 3,000/1. In some cases, the molar ratio of hydrogen peroxide to dye molecules is at least 1,000/1, or at least 3,000/1.

In some embodiments, the hydrogen peroxide is provided in a molar excess with respect to the perhydrolase enzyme. In some embodiments, the molar ratio of hydrogen peroxide to perhydrolase enzyme is at least about 1×10⁵/1, at least about 2×10⁵/1, at least about 5×10⁵/1, at least about 1×10⁶/1, at least about 2×10⁶/1, or even at least about 5×10⁶/1, or more. In some embodiments, the hydrogen peroxide is provided in a molar excess of about 2×10⁵/1 to 2×10⁶/1, with respect to the perhydrolase enzyme.

It may in some circumstances be desirable to add catalase to the textile bath to destroy residual hydrogen peroxide. In such cases, catalase can generally be added directly to the bath, without prior rinsing of the textiles.

### Laccase Enzyme System

In some embodiments, the compositions and methods include treatment with a laccase or related enzyme system to effect a cast, color, or shade change of the textile. The laccase system may be used sequentially with treatment with a perhydrolase enzyme. Moreover, the laccase system can be used before or after the perhydrolase system to produce a wide range of finishes and colors.

Laccases and laccase-related enzymes include enzymes of the classification EC 1.10.3.2. Laccase enzymes are known from microbial and plant origin. A microbial laccase enzyme may be derived from bacteria or fungi (including filamentous fungi and yeasts) and suitable examples include a laccase derivable from a strain of Aspergillus, Neurospora, e.g., N. crassa. Podospora, Botrytis, Collybia, Cerrena, e.g., Cerrena unicolor, Stachybotrys, Panus, e.g., Panus rudis, Thielavia, Fomes, Lentinus, Pleurotus, Trametes, e.g. T. villosa and T. versicolor, Rhizoctonia, e.g., R. solani, Coprinus, e.g. C. plicatilis and C. cinereus, Psatyrella, Myceliophthora, e.g., M. thermonhila, Schytalidium, Phlebia, e.g., P. radita (WO 92/01046), or Coriolus, e.g., C. hirsutus (JP 2-238885), Spongipellis sp., Polyporus, Ceriporiopsis subvermispora, Ganoderma tsunodae and Trichoderma.

A laccase or laccase related enzyme may be produced by culturing a host cell transformed with a recombinant DNA vector which includes a DNA sequence encoding the laccase as well as DNA sequences permitting the expression of the DNA sequence encoding the laccase, in a culture medium under conditions permitting the expression of the laccase enzyme, and recovering the laccase from the culture.

An expression vector containing a polynucleotide sequence encoding a laccase enzyme may be transformed into a suitable host cell. The host cell may be a fungal cell, such as a filamentous fungal cell, examples of which include but are not limited to species of Trichoderma (e.g., Trichoderma reesei (previously classified as T. longibrachiatum and currently also known as Hypocrea jecorina), Trichoderma viride, Trichoderma koningii, Trichoderma harzianum), Aspergillus spp. (e.g., Aspergillus niger, Aspergillus nidulans, Aspergillus oryzae, Aspergillus awamori), Penicillium spp., Humicola spp. (e.g. Humicola insolens, Humicola grisea, Fusarium spp. (e.g., Fusarium graminum, Fusarium venenatum), Neurospora spp., Hypocrea spp., and Mucor spp. A host cell for expression of a laccase enzyme may also be a cell of a Cerrena species, e.g., Cerrena unicolor. Fungal cells may be transformed by a process involving protoplast formation and transformation of the protoplasts followed by regeneration of the cell wall using techniques known in the art. Alternatively, the host organism may be a bacterium, such as species of Bacillus spp. (e.g., Bacillus subtilis, Bacillus licheniformis, Bacillus lentus, Bacillus stearothremophilus, Bacillus brevis), Pseudomonas, Streptomyces (e.g., Streptomyces coelicolor, Streptomyces lividans), or E. coli. The transformation of bacterial cells may be performed according to conventional methods, e.g., as described in T. Maniatis et al., Molecular Cloning: A Laboratory Manual, Cold Spring Harbor, 1982. The screening of appropriate DNA sequences and construction of vectors may also be carried out by standard procedures.

The medium used to culture the transformed host cells may be any conventional medium suitable for growing the host cells. In some embodiments, the expressed enzyme is secreted into the culture medium and may be recovered therefrom by well-known procedures in the art. For example, laccases may be recovered from a culture medium as described in U.S. Publication No. 2008/0196173. In some embodiments, the enzyme is expressed intracellularly and is recovered following disruption of the cell membrane.

In an embodiment, the expression host may be Trichoderma reesei with the laccase coding region under the control of a CBH1 promoter and terminator. (See, e.g., U.S. Pat. No. 5,861,271). The expression vector may be pTrex3g, as disclosed in U.S. Pat. No. 7,413,887.

In some embodiments, laccases are expressed as described in U.S. Publication No. 2008/0196173 or U.S. Ser. No. 12/261,306.

In some embodiments, the laccases enzyme is laccase D from Cerrena unicolor, e.g., as described in International Patent Publication No. WO08/076,322. In particular embodiments, the laccase has the amino acid sequence shown, below (SEQ ID NO:4):

AIGPVADLHIVNKDLAPDGVQRPTVLAGGTFPGTLITGQKGDNFQLNVIDDLTDDRMLTPTSIH
WHGFFQKGTAWADGPAFVTQCPIIADNSFLYDFDVPDQAGTFWYHSHLSTQYCDGLRGAFVVYD
PNDPHKDLYDVDDGGTVITLADWYHVLAQTVVGAATPDSTLINGLGRSQTGPADAELAVISVEH
NKRYRFRLVSISCDPNFTFSVDGHNMTVIEVDGVNTRPLTVDSIQIFAGQRYSFVLNANQPEDN
YWIRAMPNIGRNTTTLDGKNAAILRYKNASVEEPKTVGGPAQSPLNEADLRPLVPAPVPGNAVP
GGADINHRLNLTFSNGLFSINNASFTNPSVPALLQILSGAQNAQDLLPTGSYIGLELGKVVELV
IPPLAVGGPHPFHLHGHNFWVVRSAGSDEYNFDDAILRDVVSIGAGTDEVTIRFVTDNPGPWFL
HCHIDWHLEAGLAIVFAEGINQTAAANPTPQAWDELCPKYNGLSASQKVKPKKGTAI

In some embodiments, the laccase enzyme includes is at least about 70%, 75%, 80%, 85%, 90%, 91%, 92%, 93%, 94%, 95%, 96%, 97%, 98%, 99%, or even 99.5% identical to the amino acid sequence set forth in SEQ ID NO: 4.

Suitable laccase enzyme systems may include chemical mediator agents which enhance the activity of the laccase enzyme. Such mediators act as a redox mediators to effectively shuttle electrons between the enzyme exhibiting oxidase activity and a dye, pigment (e.g., indigo), chromophore (e.g., polyphenolic, anthocyanin, or carotenoid, for example, in a colored stain), or other secondary substrate or electron donor. Chemical mediators are elsewhere referred to as enhancers and accelerators.

The mediator may be a phenolic compound, for example, methyl syringate, and related compounds, as described in PCT Application Nos. WO95/01426 and WO96/12845. The chemical mediator may also be an N-hydroxy compound, an N-oxime compound, or an N-oxide compound, for example, N-hydroxybenzotriazole, violuric acid, or N-hydroxyacetanilide. The chemical mediator may also be a phenoxazine/phenothiazine compound, for example, phenothiazine-10-propionate. The chemical mediator may further be 2,2′-azinobis-(3-ethylbenzothiazoline-6-sulfonic acid) (ABTS). Other chemical mediators are well known in the art. For example, the compounds disclosed in PCT Application No. WO95/01426 are known to enhance the activity of a laccase. In some embodiments, the mediator may be acetosyringone, methyl syringate, ethyl syringate, propyl syringate, butyl syringate, hexyl syringate, or octyl syringate.

In some embodiments, the mediator is 4-cyano-2,6-dimethoxyphenol, 4-carboxamido-2,6-dimethoxyphenol or an N-substituted derivative thereof such as, for example, 4-(N-methyl carboxamido)-2,6-dimethoxyphenol, 4-[N-(2-hydroxyethyl)carboxamido]-2,6-dimethoxyphenol, or 4-(N,N-dimethyl carboxamido)-2,6-dimethoxyphenol.

In some embodiments, the mediator is described by the following formula:

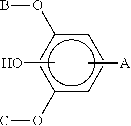

in which formula A is a group such as —R, -D, —CH═CH-D, —CH═CH—CH═CH-D, —CH═N-D, —N═N-D, or —N═CH-D, in which D is selected from the group consisting of —CO-E, —SO₂-E, —CN, —NXY, and —N⁺XYZ, in which E may be —H, —OH, —R, —OR, or —NXY, and X and Y and Z may be identical or different and selected from —H, —OH, —OR and —R; R being a C₁-C₁₆ alkyl, preferably a C₁-C₈ alkyl, which alkyl may be saturated or unsaturated, branched or unbranched and optionally substituted with a carboxy, sulfo or amino group; and B and C may be the same Or different and selected from CₘH₂ₘ+₁; 1≦m≦5.

In some embodiments, A in the above mentioned formula is —CN or —CO-E, in which E may be —H, —OH, —R, —OR, or —NXY, where X and Y may be identical or different and selected from —H, —OH, —OR and —R, R being a C₁-C₁₆ alkyl, preferably a C₁-C₈ alkyl, which alkyl may be saturated or unsaturated, branched or unbranched and optionally substituted with a carboxy, sulfo or amino group; and B and C may be the same or different and selected from CₘH₂ₘ₊₁; 1≦m≦5. In one embodiment, the mediator is 4-hydroxy-3,5-dimethoxybenzonitrile (also termed “syringonitrile” or “SN” interchangeably herein). A may be placed meta to the hydroxy group instead of being placed in the para-position, as shown.

For textile processing applications, the mediator may be present in a concentration of about 0.005 to about 1000 mmole per g textile, e.g., denim, about 0.05 to about 500 mmole per g textile, about 0.1 to about 100 mmole per g textile, about 1 to about 50 μmole per g textile, or about 2 to about 20 μmole per g textile.

The mediators may be prepared by methods known to the skilled artisan, such as those disclosed in PCT Application Nos. WO97/11217 and WO 96/12845 and U.S. Pat. No. 5,752,980. Suitable mediators for use herein are described, for example, in U.S. Publication No. 2008/0189871.

### Desizing Enzymes

The present compositions and methods for abrading and color modification may be used in combination with enzymatic desizing. Desizing is typically performed prior to abrading and to color modification. One or more desizing enzymes may be used.

In some embodiments, the desizing enzyme is an amylolytic enzyme, such as an α-amylase, a β-amylase, a mannanases, a glucoamylases, or a combination thereof.

Suitable α and β-amylases include those of bacterial or fungal origin, as well as chemically or genetically modified mutants and variants of such amylases. Suitable α-amylases include α-amylases obtainable from Bacillus species. Suitable commercial amylases include but are not limited to OPTISIZE® 40, OPTISIZE® 160, OPTISIZE® HT 260, OPTISIZE® HT 520, OPTISIZE® HT Plus, OPTISIZE® FLEX (all from Genencor), and DURAMYL™, TERMAMYL™, FUNGAMYL™ and BAN™ (all available from Novozymes A/S, Bagsvaerd, Denmark). Other suitable amylolytic enzymes include the CGTases (cyclodextrin glucanotransferases, EC 2.4.1.19), e.g., those obtained from species of Bacillus, Thermoanaerobactor or Thermoanaero-bacterium.

The activity of OPTISIZE® 40 and OPTISIZE® 160 is expressed in RAU/g of product. One RAU is the amount of enzyme which will convert 1 gram of starch into soluble sugars in one hour under standard conditions. The activity of OPTISIZE® HT 260, OPTISIZE® HT 520 and OPTISIZE® HT Plus is expressed in TTAU/g. One TTAU is the amount of enzyme that is needed to hydrolyze 100 mg of starch into soluble sugars per hour under standard conditions. The activity of OPTISIZE® FLEX is determined in TSAU/g. One TSAU is the amount of enzyme needed to convert 1 mg of starch into soluble sugars in one minute under standard conditions.

The precise dosage of the amylase varies depending on the process type. Smaller dosages would require more time than larger dosages of the same enzyme. However, there is no upper limit on the amount of desizing amylase other than what may be dictated by the physical characteristics of the solution. Excess enzyme does not hurt the fabric; it allows for a shorter processing time. Based on the foregoing and the enzyme utilized the following minimum dosages for desizing are suggested:

| | Minimum dosage | | Typical Range | |
|---|---|---|---|---|
| | (per liter of | | (per liter of | |
| Amylase Product | desizing liquor) | | desizing liquor) | |
| OPTISIZE ® 40 | 1,000 | RAU | 2,000-70,000 | RAU |
| OPTISIZE ® 160 | 1,000 | RAU | 2,000-70,000 | RAU |
| OPTISIZE ® HT 260 | 1,000 | TTAU | 3,000-100,000 | TTAU |
| OPTISIZE ® HT 520 | 1,000 | TTAU | 3,000-100,000 | TTAU |
| OPTISIZE ® HT Plus | 1,000 | TTAU | 3,000-100,000 | TTAU |
| OPTISIZE ® FLEX | 5,000 | TSAU | 13,000-65,000 | TSAU |

The desizing enzymes may be derived from the enzymes listed above in which one or more amino acids have been added, deleted, or substituted, including hybrid polypeptides, so long as the resulting polypeptides exhibit desizing activity. Such variants useful in practicing the present invention can be created using conventional mutagenesis procedures and identified using, e.g., high-throughput screening techniques such as the agar plate screening procedure.

The desizing enzyme is added to the aqueous solution (i.e., the treating composition) in an amount effective to desize the textile materials. Typically, desizing enzymes, such as α-amylases, are incorporated into the treating composition in amount from about 0.00001% to about 2% of enzyme protein by weight of the fabric, preferably in an amount from about 0.0001% to about 1% of enzyme protein by weight of the fabric, more preferably in an amount from about 0.001% to about 0.5% of enzyme protein by weight of the fabric, and even more preferably in an amount from about 0.01% to about 0.2% of enzyme protein by weight of the fabric.

### Catalase

In some embodiments, a catalase enzyme may be used to catalyze the decomposition of residual hydrogen peroxide as any stage of textile processing. Catalase is routinely used for “bleach clean-up,” which broadly refers to the destruction of residual hydrogen peroxide used to bleach (i.e., whiten and brighten) textiles prior to dying. Catalase is also routinely used for the destruction of hydrogen peroxide used to decolorize residual dyes present in aqueous dying solutions. Catalase may also be used to destroy residual hydrogen peroxide from the perhydrolase system. Catalase for bleach clean-up and to for destroy residual hydrogen peroxide from the perhydrolase system may be added directly to the bath without rinsing.

Exemplary catalase enzymes are Catalase T100 and OXY-GONE® T400, available from Genencor, and CATAZYME® or TERMINOX® Ultra, available from Novozymes. An exemplary catalase is described in European Patent No. EP 0 629 134.

### Additional Enzymes

It will be appreciated that one or more cellulase, perhydrolase, laccase, amylase, mannanase, catalase, or other enzyme mentioned, herein, may be used in the present compositions and methods. Moreover, any number of additional enzymes (or enzyme systems) can be combined with the present compositions and methods without defeating the spirit of the disclosure. Exemplary additional enzymes include but are not limited to pectate lyases, pectinases, xylanases, polyesterases, and other enzymes that have been described and/or used for textile processing.

### Methods

In some aspects, the present compositions and methods relate to enzymatic textile abrading and color modification using cellulase in combination with a perhydrolase system, in the same bath, without the need to wash or rinse the textiles between enzymatic treatments. Abrading and color modification can be performed sequentially or simultaneously. Abrading may be performed before or after color modification. For the purpose of manufacturing indigo or sulfur-dyed denim products, abrading (e.g., enzymatic “stonewashing”) using cellulase is typically performed prior to color modification using a perhydrolase system.

In other embodiments, the present compositions and methods relate to enzymatic textile abrading and color modification using cellulase in combination with a perhydrolase system and a laccase system. As described herein, abrading using cellulase and color modification using a perhydrolase system can be performed sequentially or simultaneously, in the same bath. As described in WO2010075402, abrading using cellulase and color modification using a laccase system can also be performed sequentially or simultaneously, in the same bath. However, it has also been discovered that the sequential use of a perhydrolase system and a laccase system, in either order, allows a textile manufacturer to produce a vast array of different textile finishes and colors using only a limited suite of enzyme systems.

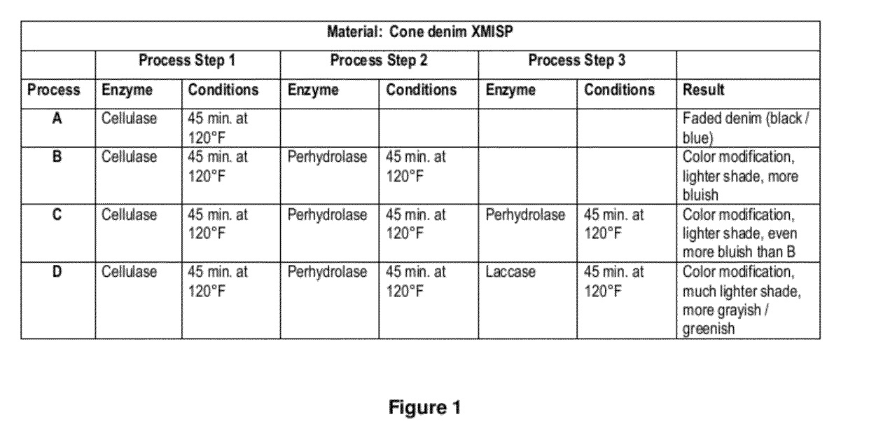

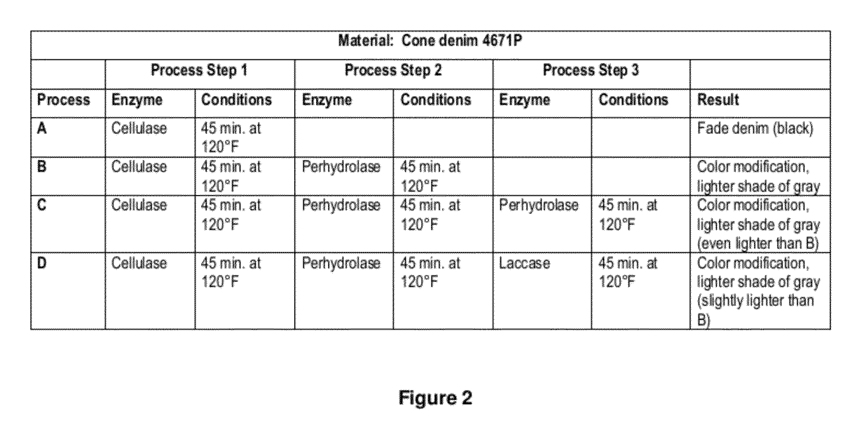

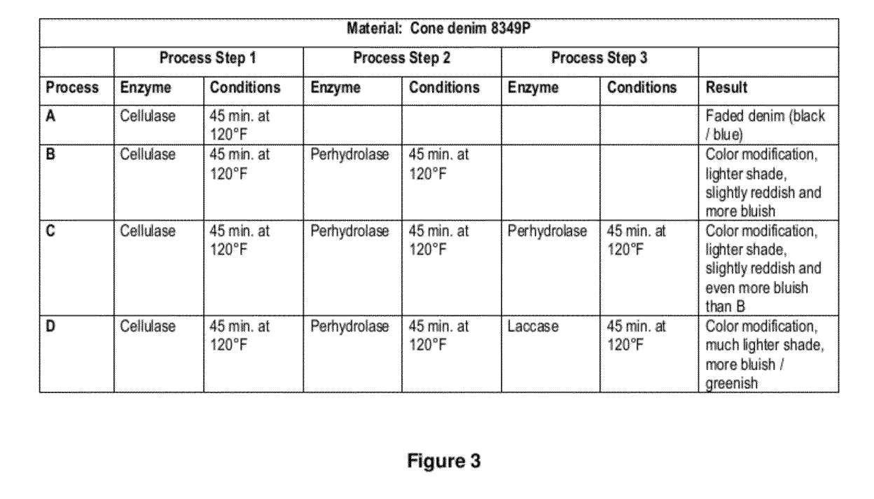

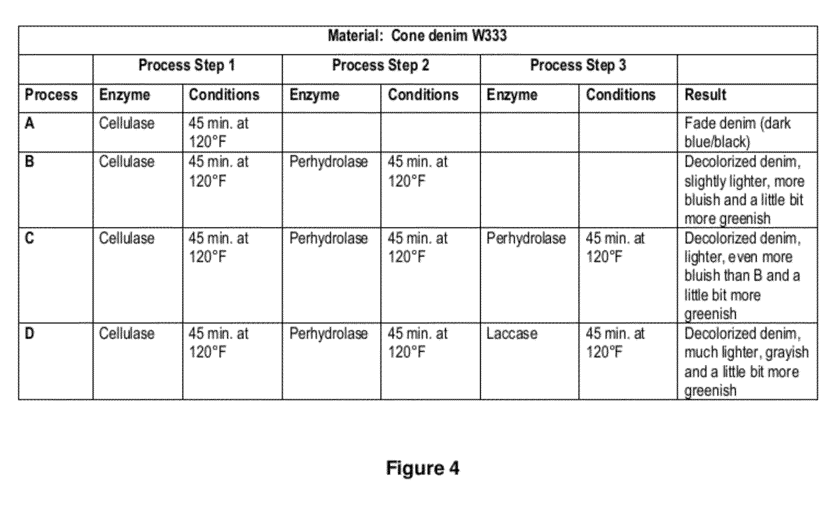

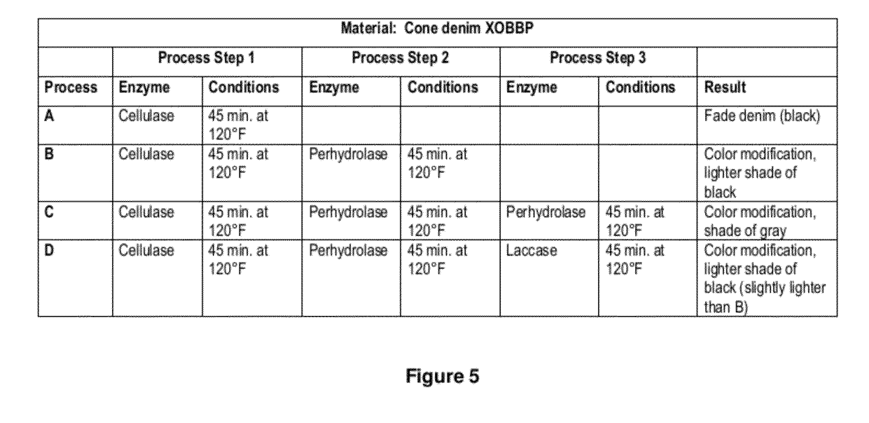

Exemplary finishes and colors for indigo-dyed denim that can be obtained using various embodiments of the present compositions and methods are listed in the Tables shown in FIGS. 1-5. The exemplary cellulase used to obtain the indicated effects was MEX-500; however, as described in the appended Examples, other acid and neutral cellulases can be used with similar results. In particular embodiments, sulfur-dyed textiles can be processed to impart a grey cast without producing a brown tint. The exemplary perhydrolase and laccase enzyme systems were PRIMAGREEN® EcoWhite 1 and PRIMAGREEN® EcoFade LT, respectively, although these exemplary systems are also non-limiting. The particular finishes and colors obtained with each exemplary process are less important than the fact that a wide array of different effects can be obtained using a limited number of enzymatic processes that are suitable for use in single-bath combinations.

Although mainly exemplified using indigo and sulfur-dyed textiles, the present methods can be used color-modify textiles dyed with a large number of dyes. Examples of dyes include, but are not limited to, azo, monoazo, disazo, nitro, xanthene, quinoline, anthroquinone, triarylmethane, paraazoanyline, azineoxazine, stilbene, aniline, and phthalocyanine dyes, or mixtures thereof. In one embodiment, the dye is an azo dye (e.g., Reactive Black 5 (2,7-naphthalenedisulfonic acid, 4-amino-5-hydroxy-3,6-bis((4-((2-(sulfooxy)ethyl)sulfonyl)phenyl)azo)-tetrasodium salt), Reactive Violet 5, methyl yellow, Congo red). In some embodiments, the dye is an anthraquinone dye (e.g., remazol blue), indigo (indigo carmine), a triarylmethane/paraazoanyline dye (e.g., crystal violet, malachite green), or a sulfur-based dye. In various embodiments, the dye is a reactive, direct, disperse, or pigment dye. In some embodiments, the dye is a component of an ink.

One class of dyes that may be oxidatively color-modified using enzymatically is the reactive dyes. Reactive dyes are chromophores that include an activated or activatable functional group capable of chemically interacting with the surface of an object to be dyed, such as a textile surface. Such interaction may take the form of a covalent bond. Exemplary functional groups include monochlorotriazine, monofluorochlorotriazine, dichlorotriazine, difluorochloropyrimidine, dichloroquinoxaline, trichloropyrimidine, vinyl amide, vinyl sulfone, and the like. Reactive dyes may have more than one functional group (e.g., bifunctional reactive dyes), thereby enabling a higher degree of fixation to a fabric.

Combined with enzymatic desizing and enzymatic bleach clean-up using an enzyme such as catalase, the present compositions and methods represent a complete enzymatic textile processing solution that allows a textile manufacturer to produce textile products with an array of different finishes and colors, using only a limited number of enzyme systems.

### Compositions and Kits of Parts

In another aspect, kits of parts are provided for performing the described methods. Such kits include, for example, (i) a single-bath abrading and color modification kit, comprising a cellulase and a perhydrolase system, (ii) a color modification kit, comprising a perhydrolase system and a laccase system, (iii) an abrading and color modification kit, comprising a cellulase, a perhydrolase system, and a laccase system, or (iv) complete enzymatic textile processing systems, which may further comprise a desizing enzyme, a catalase, a pectate lyase, or other enzymes listed herein or known in the art for use in textile processing. It will be appreciated that one or more enzymes of each type may be included in the kit.

The perhydrolase system may include a perhydrolase enzyme, a substrate for the perhydrolase enzyme, and a hydrogen peroxide source, in amounts and in ratios suitable for textile color modification. The laccase enzyme system may include a laccase enzyme and a mediator in amounts and in ratios suitable for textile color modification.

Instructions for use may be provided in printed form or in the form of an electronic medium such as a floppy disc, CD, or DVD, or in the form of a website address where such instructions may be obtained.

These and other aspects and embodiments of the present compositions and method will be apparent to the skilled person in view of the present description. The following examples are intended to further illustrate, but not limit, the compositions and methods.

### EXAMPLES

The following enzyme nomenclature is used in the Examples:

| Trade name | Description |
|---|---|
| PRIMAGREEN ® | Commercially available composition comprising the |
| EcoWhite 1 | S54V variant of Mycobacterium smegmatis |
| | perhydrolase |
| PRIMAGREEN ® | Commercially available composition comprising |
| EcoFade LT | Cerrena unicolor laccase |
| OPTISIZE ® | Commercially available composition comprising |
| 160 amylase | Bacillus amyloliquefaciens amylase |
| INDIAGE ® | Commercially available composition comprising |
| Neutra L | Streptomyces sp. 11AG8 endoglucanase |
| INDIAGE ® | Commercially available composition comprising a |
| 2XL | blend of Trichoderma reesei cellulases |
| PRIMAFAST ® | Commercially available composition comprising a |
| 200 | cellulase from Trichoderma reesei |
| STCE | Cellulase from Staphylotrichum coccosporum |
| MEX-500 | Cellulase from Humicola insolens |

### Example 1

### Effect of Perhydrolase Concentration on Color Modification of Indigo-dyed Denim

### Materials

Perhydrolase (PRIMAGREEN® EcoWhite 1 (321 U/g), available from Genencor Division, Danisco US, Inc.), was used in this experiment. H₂O₂ (30 wt %, analysis grade) and propylene glycol diacetate (PGDA, >99.7%) were purchased from Sigma Aldrich.

### Procedure

12 denim legs (ACG denim style 80270), weighing approximately 3 kg, were desized in a Unimac UF 50 front loader rotary washing machine under the following conditions:
Desizing for 15 minutes at 10:1 liquor ratio 50° C. with 0.5 g/l (15 g) of OPTISIZE® 160 amylase (Genencor) and 0.5 g/l (15 g) of a non-ionic surfactant (ULTRAVON® RW (Huntsman)).
2 cold rinse steps for 5 minutes at 30:1 liquor ratio.

Following desizing, the denim legs were stonewashed in a Unimac UF 50 washing machine according to the following program:
Cold rinsing for 5 minutes at 10:1 liquor ratio
Stonewashing for 60 minutes at 10:1 liquor ratio at 55° C. with 1 kg of pumice stone, pH 6.5-7 (1 g/l of disodium phosphate.2H₂O+0.53 g/l of citric acid H₂O) and 0.025 g/l of MEX-500 neutral cellulase (Meiji Corp., Nagoya, Japan).
2 cold rinse steps of 5 min each.

The denim was dried in a household dryer and then used to make swatches (7×7 cm).

After stonewashing, the experiments were performed in a Launder-O-meter (Rapid Laboratory Dyeing Machine type H12) according to the following process:
450 ml stainless steel reaction vessels were filled with 100 ml of pH 8 phosphate buffer (8.9 g/l of disodium phosphate.2H₂O+0.4 g/l of monosodium phosphate anhydrous).
To each vessel five (7×7 cm) stonewashed denim swatches of 10 g weight were added.
6 ml/l of H₂O₂ solution (30% wt) and 2 ml/l of PGDA (>99.7%) was added.
Perhydrolase was added at concentrations of 0.01, 0.05, 0.3, 1.0, 3.0, or 10 ml/l.
The reaction vessels were closed and loaded into the launder-O-meter, which was pre-heated to 60° C.
Incubation was performed for 60 minutes, after which the swatches were rinsed by overflow, spun dry in an AEG IPX4 centrifuge, and dried with an Elna Press Electronic iron at program cotton and evaluated.

### Evaluation of Denim Swatches

The denim swatches were evaluated after perhydrolase treatment with a Minolta Chromameter CR 310 in the CIE Lab color space with a D 65 light source. Measurements were performed before and after perhydrolase treatment and the results from five swatches were averaged. The total color difference (TCD) was calculated using the formula: TCD=√(ΔL)²+(Δa)²+(Δb)². The results are shown in Table 1.

TABLE 1

| Perhydrolase | | |
|---|---|---|
| concentration (ml/l) | TCD | ΔL/Δa/Δb |
| Buffer | 0.44 | 0.41/0.13/0.10 |
| 0.01 | 0.56 | 0.40/0.32/−0.23 |
| 0.05 | 1.46 | 1.10/0.31/−0.90 |
| 0.3 | 1.97 | 1.50/0.34/−1.23 |
| 1 | 2.11 | 1.37/0.51/−1.52 |
| 3 | 2.05 | 1.41/0.41/−1.43 |
| 10 | 1.49 | 1.19/0.42/−0.80 |

These results demonstrate that the perhydrolase enzyme system can produce a cast modification on dyed-textiles over a range of enzyme concentrations.

### Example 2

### Effect of H₂O₂ and PGDA Concentrations on Color Modification of Indigo-Dyed Denim

### Procedure

12 denim legs (ACG denim style 80270), weighing approximately 3 kg, were desized and stonewashed as described in Example 1. After stonewashing, the experiments were performed in a Launder-O-meter (Rapid Laboratory Dyeing Machine type H12) according to the following process:
450 ml stainless steel reaction vessels were filled with 100 ml of pH 8 phosphate buffer (8.9 g/l of disodium phosphate.2H₂O+0.4 g/l of monosodium phosphate anhydrous).
To each vessel five (7×7 cm) stonewashed denim swatches of 10 g weight were added.
H₂O₂ solution (30% wt) and PGDA (>99.7%) were added according to the experimental design as shown in Table 2.1.

TABLE 2.1

| [H₂O₂] (ml/l) | [PGDA] (ml/l) |
|---|---|
| 7.55 | 3.8 |
| 15 | 7.5 |
| 0.1 | 7.5 |
| 7.55 | 3.8 |
| 0.1 | 0.1 |
| 15 | 0.1 |
| 7.55 | 3.8 |
| 6.0 | 3.0 |
| 0 | 3.0 |
| 6.0 | 0 |
| 15 | 3.8 |
| 7.55 | 7.5 |

1.0 ml/l of perhydrolase was added (PRIMAGREEN® EcoWhite 1 (321 U/g)).
The reaction vessels were closed and loaded into the Launder-O-Meter which was pre-heated to 60° C.
Incubation was performed for 60 minutes, after which the swatches were rinsed by overflow, spun dry in an AEG IPX4 centrifuge, and dried with an Elna Press Electronic iron at program cotton, and evaluated.

### Evaluation of Denim Swatches

The denim swatches were evaluated after perhydrolase treatment with a Minolta Chromameter CR 310 in the CIE Lab color space with a D 65 light source. Measurements were performed before and after perhydrolase treatment and the results from five swatches were averaged. The total color difference (TCD) was calculated using the formula: TCD=√(ΔL)²+(Δa)²+(Δb)². The results are shown in Table 2.2.

TABLE 2.2

| [H₂O₂] (mm) | [PGDA] (ml/l) | TCD | ΔL/Δa/Δb |
|---|---|---|---|
| 7.55 | 3.8 | 2.33 | 1.03/0.36/−1.24 |
| 15 | 7.5 | 2.48 | 1.11/0.40/−1.37 |
| 0.1 | 7.5 | 1.09 | 0.57/0.02/0.00 |
| 7.55 | 3.8 | 2.31 | 1.04/0.45/−1.17 |
| 0.1 | 0.1 | 0.76 | 0.07/−0.04/−0.06 |
| 15 | 0.1 | 1.48 | 0.66/0.12/−0.49 |
| 6.0 | 3.0 | 2.55 | 1.50/0.24/−1.17 |
| 0 | 3.0 | 0.62 | 0.15/−0.06/0.22 |
| 6.0 | 0 | 0.80 | −0.22/0.10/−0.15 |
| 15 | 3.8 | 2.17 | 0.62/0.43/−1.28 |
| 7.55 | 7.5 | 2.37 | 1.17/0.35/−1.19 |

These results demonstrate that the perhydrolase enzyme system can produce a cast modification on dyed-textiles over a range of hydrogen peroxide and PGDA concentrations.

### Example 3

### Effect of Time on Color Modification of Indigo-Dyed Denim

### Procedure

12 denim legs (ACG denim style 80270), weighing approximately 3 kg, were desized and stonewashed as described in Example 1. After stonewashing, the experiments were performed in a Launder-O-meter (Rapid Laboratory Dyeing Machine type H12) according to the following process.
450 ml stainless steel reaction vessels were filled with 100 ml of pH 8 phosphate buffer (8.9 g/l Disodium phosphate.2H₂O+0.4 g/l Monosodium phosphate anhydrous).
To each vessel five (7×7 cm) stonewashed denim swatches of 10 g weight were added.
6 ml/l of H₂O₂ solution (30% wt) and 0.2 ml/l of PGDA (>99.7%) were added. 11.0 g/l of perhydrolase was added (PRIMAGREEN® EcoWhite 1 (321 U/g)).
The reaction vessels were closed and loaded into the Launder-O-Meter, which was pre-heated to 60° C.
Incubation was performed for 10, 20, 30, 40, 50, or 60 minutes, after which the swatches were rinsed by overflow, spun dry in an AEG IPX4 centrifuge, dried with an Elna Press Electronic iron at program cotton, evaluated.

### Evaluation of Denim Swatches

The denim swatches were evaluated after perhydrolase treatment with a Minolta Chromameter CR 310 in the CIE Lab color space with a D 65 light source. Measurements were performed before and after perhydrolase treatment and the results from five swatches were averaged. The total color difference (TCD) was calculated using the formula: TCD=√(ΔL)²+(Δa)²+(Δb)². The results are shown in Table 3.

TABLE 3

| Time | TCD | ΔL/Δa/Δb |
|---|---|---|
| (buffer) | 1.09 | 1.05/0.27/0.05 |
| 10 | 1.48 | 0.97/0.30/−1.08 |
| 20 | 2.17 | 1.51/0.45/−1.49 |
| 30 | 2.05 | 1.28/0.53/−1.51 |
| 40 | 2.24 | 1.57/0.44/−1.55 |
| 50 | 2.45 | 1.80/0.49/−1.59 |
| 60 | 2.62 | 1.99/0.46/−1.64 |

These results demonstrate that the perhydrolase enzyme system can produce a cast modification on dyed-textiles in a time-dependent manner.

### Example 4

### Effect of Temperature on Color Modification of Indigo-Dyed Denim

### Procedure

12 denim legs (ACG denim style 80270), weighing approximately 3 kg, was desized and stonewashed as described in Example 1. After stonewashing, the experiments were performed in a Launder-O-meter (Rapid Laboratory Dyeing Machine type H12) according to the following process.
450 ml stainless steel reaction vessels were filled with 100 ml of pH 8 phosphate buffer (8.9 g/l of disodium phosphate.2H₂O+0.4 g/l of monosodium phosphate anhydrous).
To each vessel five (7×7 cm) stonewashed denim swatches of 10 g weight were added.
6 ml/l of H₂O₂ solution (30% wt) and 2 ml/l of PGDA (>99.7%) was added.
1.0 ml/l of perhydrolase was added (PRIMAGREEN® EcoWhite 1 (321 U/g)).
The reaction vessels were closed and loaded into the Launder-O-Meter, which was pre-heated to 30, 40, 50 or 60° C.
Incubation was performed for 60 minutes, the swatches rinsed by overflow, spun dry in an AEG IPX4 centrifuge, dried with an Elna Press Electronic iron at program cotton, evaluated.

### Evaluation of Denim Swatches

The denim swatches were evaluated after perhydrolase treatment with a Minolta Chromameter CR 310 in the CIE Lab color space with a D 65 light source. Measurements were performed before and after perhydrolase treatment and the results from five swatches were averaged. The total color difference (TCD) was calculated using the formula: TCD=√(ΔL)²+(Δa)²+(Δb)². The results are shown in Table 4.

TABLE 4

| Temperature ° C. | TCD | ΔL/Δa/Δb |
|---|---|---|
| 30 (buffer only) | 0.93 | 0.91/0.07/0.16 |
| 30 | 1.36 | 1.20/0.28/−0.57 |
| 40 (buffer only r) | 0.78 | 0.77/0.11/−0.02 |
| 40 | 1.55 | 1.26/0.28/−0.86 |
| 50 (buffer only) | 1.07 | 1.06/0.11/−0.02 |
| 50 | 2.02 | 1.63/0.32/−1.14 |
| 60 (buffer only) | 0.9 | 0.86/0.24/−0.15 |
| 60 | 2.21 | 1.67/0.44/−1.38 |

These results demonstrate that the perhydrolase enzyme system can produce a cast modification on dyed-textiles under different temperature conditions.

### Example 5

### Abrading and Color Modification of Indigo-Dyed Denim using a Sequential Cellulase-Perhydrolase Process

### Procedure

12 denim legs (ACG denim style 80270), weighing approximately 3 kg, were desized in a Unimac UF 50 washing machine under the following conditions:
Desizing for 15 minutes at 10:1 liquor ratio 50° C. with 0.5 g/l (15 g) of OPTISIZE® 160 amylase (Genencor) and 0.5 g/l (15 g) of a non-ionic surfactant (ULTRAVON® RW; Huntsman).
2 cold rinses for 5 minutes at 30:1 liquor ratio.

Following desizing, the denim was stonewashed in a Unimac UF 50 rotary washing machine according to the following procedure:
Cold rinse for 5 minutes at 10:1 liquor ratio
Stonewashing for 60 minutes at 10:1 liquor ratio 55° C. with 1 kg of pumice stone, pH 4.8 (1 g/l of trisodium citrate 2 H₂O+0.87 g/l of citric acid H2O) 1.17 g/l of INDIAGE® 2XL cellulase (Genencor)
2 cold rinse steps of 5 min each.
4 legs taken out as a control.

After stonewashing, treatment with perhydrolase was performed in a Unimac UF 50 washing machine according to the following process:
60 minutes at 10:1 liquor ratio, with 1 g/l perhydrolase (PRIMAGREEN® EcoWhite 1 (321 U/g)), 6 g/l of H₂O₂ solution (30% wt) and 3 g/l of PGDA (>99.7%) at pH 7 (1 g/l of disodium phosphate.2 H₂O and 0.17 g/l of citric acid) and temperature of 60° C. The pH was maintained at 7 by adding 4 M of sodium hydroxide solution.
2 cold rinses for 5 minutes at 30:1 liquor ratio.
The denim was dried in a household dryer.

### Evaluation of Denim Legs

Bleaching of denim legs was evaluated after treatment with a Minolta Chromameter CR 310 in the CIE Lab color space with a D 65 light source. For each denim leg, 8 measurements were taken and the results of the 12 legs (96 measurements) were averaged. The results are shown in Table 5.

TABLE 5

| Treatment | L/a/b |
|---|---|
| Perhydrolase treatment | 36.3/−0.29/−15.17 |

These results demonstrate that the perhydrolase enzyme system can produce a cast modification on dyed-textiles in a sequential cellulase-perhydrolase process in a large-scale scale machine.

### Example 6

### Abrading and Color Modification of Indigo-dyed Denim using a Sequential Cellulase-Laccase-Perhydrolase Process

### Procedure

Denim, 12 legs (ACG denim style 80270) weighing approximately 3 kg, was desized in a Unimac UF 50 washing machine under the following conditions:
Desizing for 15 minutes at 10:1 liquor ratio 50° C. with 0.5 g/l (15 g) of OPTISIZE® 160 amylase (Genencor) and 0.5 g/l (15 g) of a non-ionic surfactant (ULTRAVON® RW (Huntsman).
2 cold rinses for 5 minutes at 30:1 liquor ratio.

Following desizing, the denim was stonewashed in a Unimac UF 50 rotary washing machine according to the following procedure:
Cold rinse for 5 minutes at 10:1 liquor ratio
Stonewashing for 60 minutes at 10:1 liquor ratio 55° C. with 1 kg of pumice stone, pH 4.8 (1 g/l of trisodium citrate.2 H₂O+0.87 g/l of citric acid H₂O) and 1.17 g/l of INDIAGE® 2XL (Genencor)
2 cold rinse steps of 5 min each.

After stonewashing, laccase treatment was performed in a Unimac UF 50 washing machine according to the following process:
30 minutes at 10:1 liquor ratio, with 3 g/l of ready to use PRIMAGREEN® EcoFade LT 100 (Genencor) laccase and laccase mediator at pH 6 and temperature of 30° C.
2 cold rinses for 5 minutes at 30:1 liquor ratio.
The denim was dried in a household dryer.

After bleaching with laccase, treatment with perhydrolase was performed in a Unimac UF 50 washing machine according to the following process:
60 minutes at 10:1 liquor ratio, with 1 g/l of perhydrolase (PRIMAGREEN® EcoWhite 1 (321 U/g)), 6 g/l of H₂O₂ solution (30% wt) and 3 g/l of PGDA (>99.7%) at pH 8 (8.9 g/l disodium phosphate.2H₂O+0.4 g/1 monosodium phosphate anhydrous) and temperature of 60° C.
2 cold rinses for 5 minutes at 30:1 liquor ratio
The denim was dried in a household dryer

### Evaluation of Denim Legs

Bleaching of denim legs was evaluated after laccase treatment and after perhydrolase treatment with a Minolta Chromameter CR 310 in the CIE Lab color space with a D 65 light source. For each denim leg, 8 measurements were taken and the results of the 12 legs (96 measurements) were averaged. The results are shown in Table 6.

TABLE 6

| Treatment | L/a/b |
|---|---|
| Laccase | 40.5/−1.5/−12.1 |
| Laccase + Perhydrolase | 44.4/−1.3/−15.2 |

These results demonstrate that the perhydrolase enzyme system can be used in combination with a laccase enzyme system to produce a different color modification.

### Example 7

### Color Modification of Pure Indigo-dyed Denim using Perhydrolase

### Materials

Perhydrolase (PRIMAGREEN® EcoWhite 1, 326 U/g, 1.5 mg enzyme protein/g) was used in this experiment. H₂O₂ (30 wt %, analysis grade) and PGDA (>99.7%) were purchased from Sigma Aldrich.

### Procedure

12 denim legs weighing approximately 3 kg, was desized in a Unimac UF 50 washing machine under the following conditions:
Desizing for 15 minutes at 10:1 liquor ratio 50° C. with 0.5 g/l (15 g) of OPTISIZE® 160 amylase (Genencor) and 0.5 g/l (15 g) of a non-ionic surfactant (ULTRAVON® RW) (Huntsman).
2 cold rinses for 5 minutes at 30:1 liquor ratio.

Following the desizing the denim was stonewashed in a Unimac UF 50 rotary washing machine according to the following program:
Cold rinse for 5 minutes at 10:1 liquor ratio.
Stonewashing for 60 minutes at 10:1 liquor ratio 55° C. with 1 kg of pumice stone, pH 4.8 (1 g/l of trisodium citrate.2 H₂O+0.87 g/l of citric acid H₂O) 1.17 g/l of INDIAGE® 2XL cellulase (Genencor).
2 cold rinse steps of 5 min each.
6 legs were taken out and dried for evaluation.

After stonewashing, treatment with perhydrolase was performed in a Unimac UF 50 washing machine according to the following process:
60 minutes at 10:1 liquor ratio, with 1 g/l of perhydrolase (PRIMAGREEN® EcoWhite 1, 326 U/g, 1.5 mg enzyme protein/g), 6 g/l of H₂O₂ solution (30% wt) and 3 g/l of PGDA (>99.7%) at pH 8 (9.0 g/l disodium phosphate.2H₂O+0.3 g/1 monosodium phosphate anhydrous) and temperature of 60° C.
2 cold rinses for 5 minutes at 30:1 liquor ratio.
The denim was dried in a household dryer

### Evaluation of Denim Legs

Bleaching of denim legs was evaluated after laccase treatment and after perhydrolase treatment with a Minolta Chromameter CR 310 in the CIE Lab color space with a D 65 light source. For each denim leg, 8 measurements were taken and the results of the 12 legs (96 measurements) were averaged. The results are shown in Table 7.

TABLE 7

| Treatment | L/a/b |
|---|---|
| Stonewashing | 23.52/1.45/−11.85 |
| Stonewashing + perhydrolase | 25.47/1.23/−13.49 |

These results demonstrate that the perhydrolase enzyme system can produce a cast modification on pure indigo-dyed-textiles in a sequential cellulase-perhydrolase process.

### Example 8

### Abrading and Color Modification of Denim using a Single-Bath Cellulase-Perhydrolase Process

### Procedure

Desized denim, (2 legs for evaluation+ballast), weighing approximately 3 kg, was stonewashed in a Renzacci LX 22 rotary washing machine according to the following protocol:
40 minutes at 10:1 liquor ratio 50° C., pH 6.5 with 0.4% INDIAGE® Neutra L cellulase (Batch No. 40105358001, 5,197 NPCNU/g (Genencor)).
After stonewashing 1 leg was taken out and dried for evaluation.
Following stonewashing, without drain the bath, the denim was treated with perhydrolase according to the following protocol:
   40 minutes at 10:1 liquor ratio, with 1 g/l perhydrolase (PRIMAGREEN® EcoWhite 1,326 U/g, 1.5 mg enzyme protein/g), 6 g/l of H₂O₂ solution (30% wt) and 3 g/l of PGDA (>99.7%) at pH 11 (2 g/l of soda ash) and temperatures of 50° C.
   2 cold rinses for 3 minutes
   The denim was dried in an industrial dryer.

### Evaluation of Denim Legs

Color adjustment of denim legs was evaluated after treatment with perhydrolase with a Minolta Chromameter CR 310 in the CIE Lab color space with a D 65 light source. For each denim leg, 6 measurements were taken and the results were averaged. The results are shown in Table 8.

TABLE 8

| Treatment | L/a/b |
|---|---|
| Stonewashing | 28.45/0.97/−13.25 |
| Stonewashing + perhydrolase | 31.12/0.50/−14.14 |
| in a single bath | |

These results demonstrate that the perhydrolase enzyme system can be used in a sequential, single-bath cellulase-perhydrolase process.

### Example 9

### Abrading and Color Modification of Denim Using a Sequential Cellulase-Perhydrolase-Laccase Process

### Procedure

Desized denim, (2 legs for evaluation+ballast), weighing approximately 6 kg, was mild stonewashed in a belly washer according to the following protocol:
Stonewashing for 40 minutes at 10:1 liquor ratio 50° C. pH 6.5 with 0.1% INDIAGE®Neutra L cellulase (Batch No. 40105358001, 5,197 NPCNU/g (Genencor)).
2 cold rinse steps of 3 min each

After stonewashing with cellulase, treatment with perhydrolase was performed in a belly washer according to the following process:
40 minutes at 15:1 liquor ratio, 1 g/l of perhydrolase, 6 g/l of H₂O₂ solution (30% wt) and 3 g/l of PGDA (>99.7%) at pH 11 (2.0 g/l soda ash) and temperature of 50° C.
2 cold rinses for 3 minutes

After color adjustment, laccase treatment was performed in a belly washer according to the following process:
40 minutes at 15:1 liquor ratio, with 1 g/l of the ‘ready to use’ PRIMAGREEN® EcoFade LT 100 (Batch No. 780913616 6292 GLacU/g (Genencor)) laccase and laccase mediator at 40° C.
2 cold rinses for 3 minutes.
1 leg was take out for evaluation and dried in a industrial dryer.

After bleaching with laccase, color adjustment treatment with perhydrolase was performed in a Belly washer according to the following process:
40 minutes at 15:1 liquor ratio, 1 g/l of perhydrolase (PRIMAGREEN® EcoWhite 1, 326 U/g, 1.5 mg enzyme protein/g), 6 g/l of H₂O₂ solution (30% wt) and 3 g/l of PGDA (>99.7%) at pH 11 (2.0 g/l soda ash) and temperature of 50° C.
2 cold rinses for 3 minutes
The denim was dried in a industrial dryer

### Evaluation of Denim Legs

Bleaching and color adjustment of denim legs was evaluated after laccase treatment and after perhydrolase treatment with a Minolta Chromameter CR 310 in the CIE Lab color space with a D 65 light source. For each denim leg, 6 measurements were taken and the results were averaged. The results are shown in Table 9.

TABLE 9

| Treatment | L/a/b |
|---|---|
| Cellulase + perhydrolase + | 40.47/−1.28/−12.07 |
| laccase | |
| Cellulase + perhydrolase + | 42.35/−1.02/−13.71 |
| laccase + perhydrolase | |

These results demonstrate that the perhydrolase enzyme system can be used in different combinations with cellulase and a laccase enzyme system, to produce unique finishing effects.

### Example 10

### Color Modification of Sulfur-Dyed Khaki Garments Using Perhydrolase

### Materials

Perhydrolase (PRIMAGREEN® EcoWhite 1,326 U/g, 1.5 mg enzyme protein/g) was used in this experiment. H₂O₂ (30 wt %, analysis grade), PGDA (>99.7%) were purchased from Sigma Aldrich.

### Procedure

Sulfur-dyed garments weighing approximately 2 kg, were stonewashed in a Unimac UF 50 rotary washing machine according to the following program:
Cold rinse for 5 minutes at 15:1 liquor ratio.
Stonewashing for 60 minutes at 15:1 liquor ratio 55° C., pH 4.8 (1 g/l of trisodium citrate.2 H₂O+0.87 g/l of citric acid H₂O) 1.0 g/l of INDIAGE® 2XL cellulase (Genencor).
2 cold rinse steps of 5 min each.
The garments were taken out and dried for evaluation.

After stonewashing, treatment with perhydrolase was performed in a Unimac UF 50 washing machine according to the following process:
60 minutes at 15:1 liquor ratio, with 1 g/l of perhydrolase (PRIMAGREEN® EcoWhite 1,326 U/g, 1.5 mg enzyme protein/g), 6 g/l of H₂O₂ solution (30% wt) and 3 g/l of PGDA (>99.7%) at 2 g/l of sodium carbonate (pH 11) and temperature of 50° C.
2 cold rinses for 5 minutes at 30:1 liquor ratio.
The garments were dried in a household dryer

### Evaluation of Denim Legs

Bleaching of denim legs was evaluated after perhydrolase treatment with a Minolta Chromameter CR 310 in the CIE Lab color space with a D 65 light source. For each garment, 16 measurements were taken. The results are shown in Table 10.

TABLE 10

| Treatment | L/a/b |
|---|---|
| Stonewashing | 23.00/1.36/−1.18 |
| Stonewashing + perhydrolase | 26.72/1.44/−0.52 |

These results demonstrate that the perhydrolase enzyme system can produce color modification on sulfur-dyed khaki garments.

### Example 11

### Abrading and Color Modification of Denim using a Single-Bath Acid Cellulase-Perhydrolase Process

### Procedure

100% cotton, and 65% cotton/35% polyester sulfur-dyed legs weighing approximately 5 kg, were desized in a twin belly washer YXG-80×2 under the following conditions:
Desizing for 15 minutes at 15:1 liquor ratio 60° C. with 0.4 g/l of OPTISIZE® 160 amylase (Genencor) and 0.5 g/l of a non-ionic surfactant (ULTRAVON® RW; Huntsman).
2 cold rinse steps for 2 minutes at 30:1 liquor ratio.

Desized legs (4 legs 100% cotton sulfur-dyed and 4 legs 65% cotton/35% polyester sulfur-dyed+ballast), weighing approximately 5 kg, were stonewashed in twin belly washer YXG-80×2 according to the following protocol:
30 minutes at 15:1 liquor ratio 50° C., pH 4.7 (set with 20 ml 99.8% acetic acid) with 0.5 g/l PRIMAFAST® 200 cellulase from Genencor.
After stonewashing 4 legs (2 legs 100% cotton sulfur-dyed and 2 legs 65% cotton/35% polyester sulfur-dyed) were taken out and dried for evaluation

Following stonewashing, and without draining the bath, the legs were treated with perhydrolase according to the following protocol:
60 minutes at 15:1 liquor ratio, with 1 g/l perhydrolase (PRIMAGREEN® EcoWhite 1,326 U/g, 1.5 mg enzyme protein/g), 6 g/l of H₂O₂ solution (30% wt) and 3 g/l of PGDA (>99.7%) at pH 7.6 (12 g/l of a blend 95% disodium phosphate dihydrate+5% of monosodium phosphate anhydrous) and temperatures of 60° C.
2 cold rinses for 2 minutes.
The denim was dried in an industrial dryer.

### Evaluation of Denim Legs

Color adjustment of the sulfur-dyed legs was evaluated after treatment with perhydrolase with a Minolta Chromameter CR 310 in the CIE Lab color space with a D 65 light source. For each denim leg, 4 measurements were taken and the results were averaged. The results are shown in Table 11.

TABLE 11

| | L/a/b |
|---|---|
| 100% cotton sulfur-dyed legs | |
| Stonewashing | 25.01/1.35/−1.86 |
| Stonewashing + perhydrolase | 35.25/1.49/−1.92 |
| in a single bath | |
| 65% cotton/35% polyester | |
| sulfur-dyed legs | |
| Stonewashing | 21.92/1.78/−2.28 |
| Stonewashing + perhydrolase | 33.65/1.76/−2.08 |
| in a single bath | |

These results demonstrate that the perhydrolase enzyme system can produce color modification on sulfur-dyed 100% cotton and cotton blend materials, when used in combination with an acid cellulase in a single-bath, cellulase-perhydrolase process.

### Example 12

### Abrading and Color Modification of Denim using a Single-Bath Neutral Cellulase-Perhydrolase Process

### Procedure

100% cotton, and 65% cotton/35% polyester legs, weighing approximately 5 kg, were desized in a twin belly washer YXG-80×2 under the following conditions:
Desizing for 15 minutes at 15:1 liquor ratio 60° C. with 0.4 g/l of OPTISIZE® 160 amylase (Genencor) and 0.5 g/l of a non-ionic surfactant (ULTRAVON® RW; Huntsman).
2 cold rinse steps for 2 minutes at 30:1 liquor ratio.

Desized legs (4 legs 100% cotton sulfur-dyed and 4 legs 65% cotton/35% polyester sulfur-dyed+ballast), weighing approximately 5 kg, were stonewashed in twin belly washer YXG-80×2 according to the following protocol:
30 minutes at 15:1 liquor ratio 50° C., pH 7.3 (set with 65 ml of 5% acetic acid solution) 0.1 g/l STCE cellulase (Meiji Corp., Nagoya, Japan).
After stonewashing 4 legs (2 legs 100% cotton sulfur-dyed and 2 legs 65% cotton/35% polyester sulfur-dyed) were taken out and dried for evaluation

Following stonewashing, and without drain the bath, the legs were treated with perhydrolase according to the following protocol:
60 minutes at 15:1 liquor ratio, with 1 g/l perhydrolase (PRIMAGREEN® EcoWhite 1,326 U/g, 1.5 mg enzyme protein/g), 6 g/l of H₂O₂ solution (30% wt) and 3 g/l of PGDA (>99.7%) at pH 7.6 (12 g/l of a blend 95% disodium phosphate dihydrate+5% of monosodium phosphate anhydrous) and temperatures of 60° C.
2 cold rinses for 2 minutes.
The denim was dried in an industrial dryer.

### Evaluation of Denim Legs

Color adjustment of the sulfur-dyed legs was evaluated after treatment with perhydrolase with a Minolta Chromameter CR 310 in the CIE Lab color space with a D 65 light source. For each denim leg, 4 measurements were taken and the results were averaged. The results are shown in Table 12.

TABLE 12

| | L/a/b |
|---|---|
| 100% cotton sulfur-dyed legs | |
| Stonewashing | 25.36/1.32/−1.92 |
| Stonewashing + perhydrolase | 36.75/1.49/−1.77 |
| in a single bath | |
| 65% cotton + 35% polyester | |
| sulfur-dyed legs | |
| Stonewashing | 21.83/1.79/−2.27 |
| Stonewashing + perhydrolase | 34.51/1.76/−1.99 |
| in a single bath | |

These results demonstrate that the perhydrolase enzyme system can produce color modification on sulfur-dyed 100% cotton and cotton blend materials, when used in combination with a neutral cellulase in a single-bath, cellulase-perhydrolase process.

Although the foregoing invention has been described in some detail by way of illustration and examples for purposes of clarity of understanding, it will be apparent to those skilled in the art that certain changes and modifications may be practiced without departing from the spirit and scope of the invention. Therefore, the description should not be construed as limiting the scope of the invention.

All publications, patents, and patent applications cited herein are hereby incorporated by reference in their entireties for all purposes and to the same extent as if each individual publication, patent, or patent application were specifically and individually indicated to be so incorporated by reference.

1. An enzymatic method for abrading and modifying the color of a dyed textile, comprising:
(a) contacting the textile with a cellulase to abrade the textile; and
(b) contacting the textile with a perhydrolase enzyme system to modify the color of the textile;
wherein (a) and (b) are performed in a single bath.

2. The method of claim 1, wherein (a) and (b) are performed sequentially or simultaneously.

3. The method of claim 1, wherein (a) is preceded by an enzymatic desizing step.

4. The method of claim 3, wherein the enzymatic desizing step is performed in the same bath as (a) and (b).

5. The method of claim 1, wherein (b) is followed by the addition of a catalase enzyme.

6. The method of claim 5, wherein the catalase enzyme is added to the same bath in which (a) and (b) are performed.

7. An enzymatic method for abrading and modifying the color of a dyed textile, comprising:
(a) contacting the textile with a composition comprising a cellulase to abrade the textile;
(b) contacting the textile with a laccase enzyme system to perform a first color modification of the textile; and
(c) contacting the textile with a perhydrolase enzyme system to perform a second color modification of the textile;
wherein the overall color modification produced by the combination of (b) and (c) is different from the first color modification in (b) and the second color modification in (c).

8. The method of claim 7, wherein (b) is performed before (c).

9. The method of claim 8, wherein (a) and (b) are performed sequentially or simultaneously in a single bath.

10. The method of claim 7, wherein (c) is performed before (b).

11. The method of claim 10, wherein (a) and (c) are performed sequentially or simultaneously in a single bath.

12. The method of claim 10 or 11, wherein (b) is followed by:
(d) contacting the textile with the perhydrolase enzyme system to perform a third color modification of the dyed textile.

13. The method of claim 7, wherein (a) is preceded by an enzymatic desizing step.

14. The method of claim 13, wherein the enzymatic desizing step is performed in the same bath as (a).

15. The method of claim 7, wherein (c) is followed by the addition of a catalase enzyme.

16. The method of claim 7, wherein catalase enzyme is added to the same bath in which any of (a), (b), and/or (c) are performed.

17. The method of claim 1, wherein the cellulase is selected from an acid cellulase, a neutral cellulase, and an alkaline cellulase.

18. The method of claim 1, wherein the perhydrolase enzyme system comprises a perhydrolase enzyme and an ester substrate, wherein the perhydrolase enzyme catalyzes perhydrolysis of the ester substrate with a perhydrolysis:hydrolysis ratio equal to or greater than 1.

19. The method of claim 1, wherein the perhydrolase enzyme system comprises a Mycobacterium smegmatis perhydrolase or a variant, thereof.

20. The method of claim 1, wherein the perhydrolase enzyme is a S54V variant of Mycobacterium smegmatis perhydrolase, or a variant, thereof.

21. The method of claim 1, wherein the laccase enzyme is a Cerrena unicolor laccase, or a variant, thereof.

22. The method of claim 1, wherein the textile is denim.

23. The method of claim 1, wherein the dye is indigo dye.

24. The method of claim 1, wherein the dye is sulfur dye.

25. A textile produced by the method of claim 1.

26. The textile of claim 25, wherein the textile is indigo-dyed denim.

27. The textile of claim 25, wherein the textile is sulfur-dyed denim.
